(19) United States
(12) Patent Application Publication
(10) Pub. No.: US 2026/0261832 A1
(43) Pub. Date: Sep. 3, 2026

(54) FIRST ELECTRONIC DEVICE, SECOND ELECTRONIC DEVICE, AND METHODS OF OPERATING THE SAME

(71) Applicant: SAMSUNG ELECTRONICS CO., LTD., Suwon-si (KR)

(72) Inventors: Jehwan SEO, Suwon-si (KR); Manoj Kumar SHARMA, Suwon-si (KR); Hojeen JEE, Suwon-si (KR); Saehun OH, Suwon-si (KR); Hyungyong LEE, Suwon-si (KR); Junhan PARK, Suwon-si (KR)

(73) Assignee: SAMSUNG ELECTRONICS CO., LTD., Suwon-si (KR)

(21) Appl. No.: 19/652,493

(22) Filed: Apr. 20, 2026

Related U.S. Application Data
(63) Continuation of application No. PCT/KR2026/000157, filed on Jan. 5, 2026.

(30) Foreign Application Priority Data
Jan. 9, 2025 (KR) 10-2025-0003739
Mar. 7, 2025 (KR) 10-2025-0029950

(51) Int. Cl. H04W 4/80; H04W 76/10

(52) U.S. Cl. CPC H04W 4/80; H04W 76/10

(57) ABSTRACT

A first electronic device controls a combined Wi-Fi and BT interface to obtain a media access control (MAC) address of the standalone BT interface; control the combined Wi-Fi and BT interface to establish a first connection according to Bluetooth communication with a second electronic device; control the combined Wi-Fi and BT interface to transmit the MAC address of the standalone BT interface to the second electronic device via the first connection and receive Wi-Fi connection information associated with the second electronic device; control the standalone BT interface to establish a second connection according to Bluetooth communication with the second electronic device, based on the MAC address of the standalone BT interface; and control the combined Wi-Fi and BT interface to establish a third connection according to Wi-Fi communication with the second electronic device, based on the Wi-Fi connection information associated with the second electronic device.

### CROSS-REFERENCE TO RELATED APPLICATIONS

This application is a continuation of International Application No. PCT/KR2026/000157, filed on Jan. 5, 2026, which is based on and claims priority to Korean Provisional Application No. 10-2025-0003739, filed on Jan. 9, 2025, and Korean Patent Application No. 10-2025-0029950, filed on Mar. 7, 2025, in the Korean Intellectual Property Office, the disclosures of which are incorporated by reference herein in their entireties.

### BACKGROUND

### 1. Field

The disclosure relates to a first electronic device, a second electronic device, and methods of operating the same, and more particularly, to a first electronic device, a second electronic device, and methods of operating the same for effectively connecting the first electronic device and the second electronic device wirelessly for communication therebetween.

### 2. Description of Related Art

An external device for providing an external input source may be connected to a display device such as a television (TV). The display device is provided with ports for connecting external input sources to the display device, and the external input sources may be connected to the display device. The external device is an external connection device connected to the TV and is for facilitating installation and management of numerous input ports by separating various input ports from the TV. By connecting only the single external device to the TV instead of connecting each of various external input sources to the TV, lines connected to the TV may be further simplified. Such an external device may be referred to as a One Connect Box. The TV and the external device may be connected by wire for communication therebetween, by using a cable. By wirelessly connecting the TV and the external device for communication therebetween, the cable connected to the TV may be removed. Thus, a method of easily connecting the TV and the external device wirelessly for communication therebetween is required.

### SUMMARY

According to an embodiment of the disclosure, a first electronic device, a second electronic device, and operating methods thereof for facilitating wireless communication connection between the first electronic device and the second electronic device are provided.

According to an embodiment of the disclosure, a first electronic device may include a communication interface comprising a standalone Bluetooth (BT) interface and a combined Wi-Fi and BT interface; memory storing one or more instructions; and at least one processor comprising processing circuitry and configured to execute the one or more instructions stored in the memory. When the one or more instructions are executed by the at least one processor individually or collectively, cause the first electronic device to: based on the first electronic device being powered on, control the combined Wi-Fi and BT interface to obtain a media access control (MAC) address of the standalone BT interface; control the combined Wi-Fi and BT interface to establish a first connection according to Bluetooth communication with a second electronic device; control the combined Wi-Fi and BT interface to transmit the MAC address of the standalone BT interface to the second electronic device via the first connection and receive Wi-Fi connection information associated with the second electronic device; control the standalone BT interface to establish a second connection according to Bluetooth communication with the second electronic device, based on the MAC address of the standalone BT interface; and control the combined Wi-Fi and BT interface to establish a third connection according to Wi-Fi communication with the second electronic device, based on the Wi-Fi connection information associated with the second electronic device.

According to an embodiment of the disclosure, a second electronic device may include a communication interface comprising a standalone Bluetooth (BT) interface and a combined Wi-Fi and BT interface; memory storing one or more instructions; and at least one processor comprising processing circuitry and configured to execute the one or more instructions stored in the memory. When the one or more instructions are executed by the at least one processor individually or collectively, cause the second electronic device to: based on receiving a Bluetooth advertising packet from a first electronic device, control the combined Wi-Fi and BT interface to establish a first connection according to Bluetooth communication with the first electronic device; control the combined Wi-Fi and BT interface to receive a media access control (MAC) address of the standalone BT interface of the first electronic device from the first electronic device via the first connection, and transmit Wi-Fi connection information associated with the second electronic device to the first electronic device; control the standalone BT interface to establish a second connection according to Bluetooth communication with the first electronic device, based on the MAC address of the standalone BT interface of the first electronic device; and control the combined Wi-Fi and BT interface to establish a third connection according to Wi-Fi communication with the first electronic device, based on the Wi-Fi connection information associated with the second electronic device.

According to an embodiment of the disclosure, a method of operating a first electronic device – that includes a standalone Bluetooth (BT) interface and a combined Wi-Fi and BT interface – includes the operations of controlling the combined Wi-Fi and BT interface to establish a first connection according to Bluetooth communication with a second electronic device; controlling the combined Wi-Fi and BT interface to transmit the MAC address of the standalone BT interface to the second electronic device via the first connection and receive Wi-Fi connection information associated with the second electronic device; controlling the standalone BT interface to establish a second connection according to Bluetooth communication with the second electronic device, based on the MAC address of the standalone BT interface; and controlling the combined Wi-Fi and BT interface to establish a third connection according to Wi-Fi communication with the second electronic device, based on the Wi-Fi connection information associated with the second electronic device.

According to an embodiment of the disclosure, a method of operating a second electronic device – that includes a standalone Bluetooth (BT) interface and a combined Wi-Fi and BT interface – includes the operations of based on receiving a Bluetooth advertising packet from a first electronic device controlling the combined Wi-Fi and BT interface to establish a first connection according to Bluetooth communication with the first electronic device; controlling the combined Wi-Fi and BT interface to receive a media access control (MAC) address of the standalone BT interface of the first electronic device from the first electronic device via the first connection, and transmit Wi-Fi connection information associated with the second electronic device to the first electronic device; controlling the standalone BT interface to establish a second connection according to Bluetooth communication with the first electronic device, based on the MAC address of the standalone BT interface of the first electronic device; and controlling the combined Wi-Fi and BT interface to establish a third connection according to Wi-Fi communication with the first electronic device, based on the Wi-Fi connection information associated with the second electronic device.

According to an embodiment of the disclosure, a non-transitory computer readable recording medium storing one or more instructions, that when executed by at least one processor of a first electronic device individually or collectively, cause the first electronic device to: based on the first electronic device being powered on, control a combined Wi-Fi and BT interface of the first electronic device to obtain a media access control (MAC) address associated with the standalone BT interface; control the combined Wi-Fi and BT interface to establish a first connection according to Bluetooth communication with a second electronic device; control the combined Wi-Fi and BT interface to transmit the MAC address of a standalone BT interface of the first electronic device to the second electronic device via the first connection and receive Wi-Fi connection information associated with the second electronic device; control the standalone BT interface to establish a second connection according to the Bluetooth communication with the second electronic device, based on the MAC address of the standalone BT interface; and control the combined Wi-Fi and BT interface to establish a third connection according to Wi-Fi communication with the second electronic device, based on the Wi-Fi connection information associated with the second electronic device.

According to an embodiment of the disclosure, a non-transitory computer readable recording medium storing one or more instructions, that when executed by at least one processor of a second electronic device individually or collectively, cause the second electronic device to: based on receiving a Bluetooth (BT) advertising packet from a first electronic device control a combined Wi-Fi and BT interface of the second device to establish the first connection according to Bluetooth communication with a first electronic device; control the combined Wi-Fi and BT interface to receive a media access control (MAC) address of a standalone BT interface of the second electronic device from the first electronic device via the first connection, and transmit Wi-Fi connection information associated with the second electronic device to the first electronic device; control the standalone BT interface to establish a second connection according to Bluetooth communication with the first electronic device, based on the MAC address of the standalone BT interface of the first electronic device; and control the combined Wi-Fi and BT interface to establish a third connection according to Wi-Fi communication with the first electronic device, based on the Wi-Fi connection information associated with the second electronic device.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an example of a system including a television (TV) and an external device connected to the TV, according to an embodiment of the disclosure;

FIG. 2 illustrates an example of a system including a first electronic device and a second electronic device, according to an embodiment of the disclosure;

FIG. 3 illustrates a detailed block diagram of a first electronic device and a second electronic device, according to an embodiment of the disclosure;

FIG. 4 is a block diagram of a first electronic device and a second electronic device, according to an embodiment of the disclosure;

FIG. 5 is a flowchart of an operating method of a first electronic device, according to an embodiment of the disclosure;

FIG. 6 is a flowchart of an operating method of a second electronic device, according to an embodiment of the disclosure;

FIG. 7 is a flowchart of a wireless connection operation between a first electronic device and a second electronic device, according to an embodiment of the disclosure;

FIG. 8 is a flowchart of a method, performed by a second electronic device, of identifying a first electronic device with which a wireless communication connection is to be established, according to an embodiment of the disclosure;

FIG. 9 is a flowchart of a method, performed by a second electronic device, of identifying a first electronic device with which a wireless communication connection is to be established, according to an embodiment of the disclosure;

FIG. 10 is a flowchart of a method, performed by a second electronic device, of identifying a first electronic device with which a wireless communication connection is to be established, according to an embodiment of the disclosure;

FIG. 11 is a flowchart of a wireless connection operation between a first electronic device and a second electronic device, according to an embodiment of the disclosure;

FIG. 12 is a flowchart of a wireless connection operation between a first electronic device and a second electronic device, according to an embodiment of the disclosure;

FIG. 13 is a flowchart illustrating an example of detailed operations in a process of wireless communication connection between a first electronic device and a second electronic device, according to an embodiment of the disclosure; and

FIG. 14 is a flowchart illustrating an example of detailed operations in a process of wireless communication connection between a first electronic device and a second electronic device, according to an embodiment of the disclosure.

### DETAILED DESCRIPTION

The terms used in the specification will be briefly defined, and the disclosure will be described in detail.

Although the terms used in the disclosure are selected from among common terms that are currently widely used in consideration of their functions in the disclosure, the terms may vary according the intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used in the disclosure are not merely designations of the terms, but the terms are defined based on the meaning of the terms and content throughout the disclosure.

Throughout the specification, when a part “includes” or “comprises” a component, unless there is a particular description contrary thereto, the part can further include other components, not excluding the other components. Also, the terms such as “unit,” “module,” or the like used in the specification indicate a unit, which processes at least one function or operation, and the unit may be implemented by hardware or software, or by a combination of hardware and software.

Throughout the disclosure, the expression “at least one of a, b or c” indicates only a, only b, only c, both a and b, both a and c, both b and c, all of a, b, and c, or variations thereof.

Hereinafter, embodiments of the disclosure will be described in detail with reference to the accompanying drawings, so that one of ordinary skill in the art may easily carry out the disclosure. The disclosure may, however, be embodied in many different forms and should not be construed as being limited to an embodiment of the disclosure set forth herein. In addition, in the drawings, parts irrelevant to the description are omitted for clarity, and like elements are denoted by like reference numerals throughout the specification.

In the specification, the term “user” refers to a person who controls the functions or operations of a computing device or an electronic device by using a control device, and may include a viewer, an administrator, or an installer.

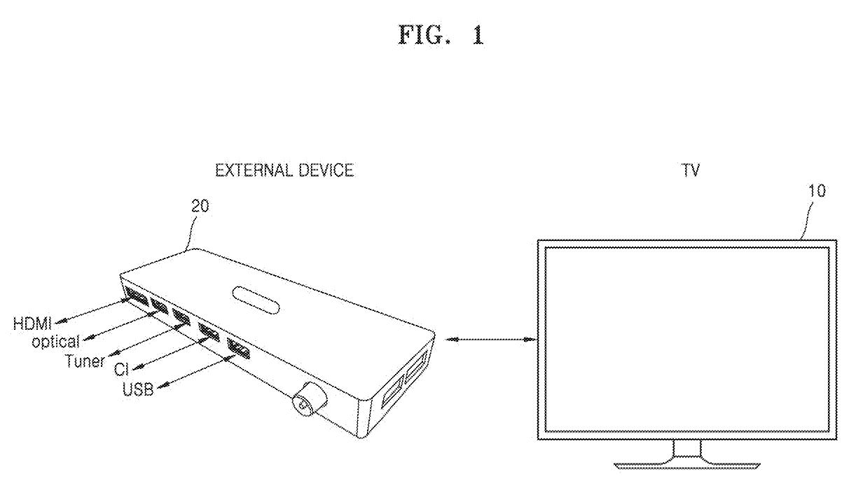

FIG. 1 illustrates an example of a system including a television (TV) and an external device connected to the TV, according to an embodiment of the disclosure.

A TV 10 may receive inputs from various external input sources. The TV 10 may be provided with ports for receiving inputs from various external input sources, and the external input sources may be connected to the ports to receive the inputs.

Instead of directly connecting various external input sources to the TV 10, an external device 20 for connection of external input sources may be provided. In other words, the external device 20 is provided with ports for connection of external input sources, for example, a high-definition multimedia interface (HDMI) port, an optical port, a tuner port, a computer interface (CI) port, a universal serial bus (USB) port, etc., and the external input sources may be connected to the external device 20. In other words, the external device 20 is an external connection device connected to the TV 10 and is a device to facilitate installation and management of numerous input ports by separating various input ports from the TV 10. By connecting only the single external device 20 to the TV 10 instead of connecting each of various external input sources to the TV 10, lines connected to the TV 10 may be further simplified. Such an external device may be referred to as a One Connect Box.

The TV 10 and the external device 20 may be connected by wire or wirelessly for communication therebetween. When the TV 10 and the external device 20 are connected by wire for communication therebetween, a single cable may be used. To eliminate even such a single cable, the TV 10 and the external device 20 may be connected wirelessly for communication therebetween.

A connection method is required that may shorten a connection time while minimizing user involvement, to wirelessly connect the TV 10 and the external device 20 for communication therebetween.

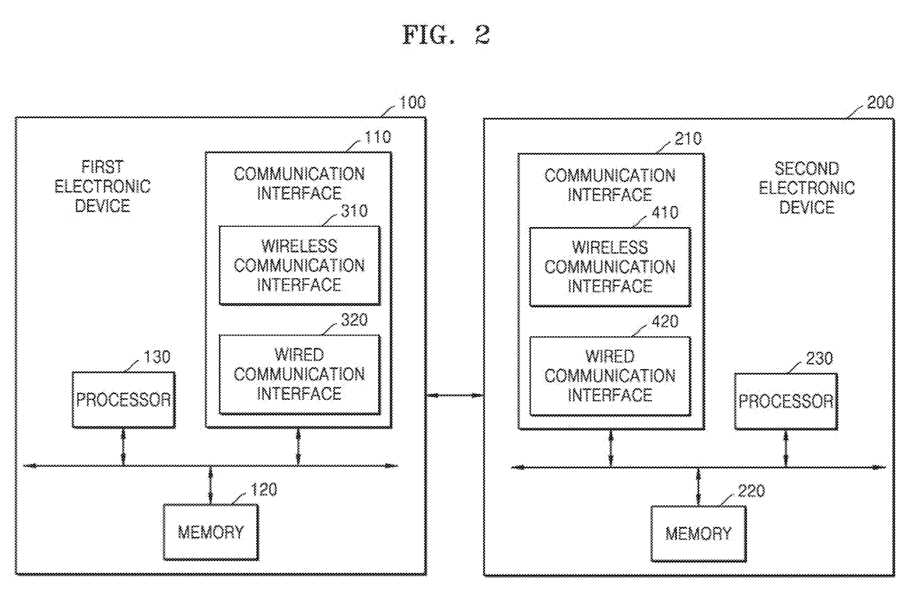

FIG. 2 illustrates an example of a system including a first electronic device and a second electronic device, according to an embodiment of the disclosure.

Referring to FIG. 2, a first electronic device 100 may establish a wireless communication connection with a second electronic device 200. The first electronic device 100 may be referred to as an external device or a source device, with respect to the second electronic device 200.

The first electronic device 100 may include a communication interface 110, memory 120, and a processor 130.

The communication interface 110 may include communication circuitry and may perform communication with at least one external device. In this regard, the “communication” may refer to an operation of transmitting and/or receiving data, a signal, a request, and/or a command. The communication interface 110 may perform wired or wireless communication with at least one external device. An external device may be the second electronic device 200. For example, the communication interface 110 may include at least one of a communication module, communication circuitry, a communication device, an input/output port, or an input/output plug for performing wired or wireless communication with at least one external device.

The communication interface 110 may include a wireless communication interface 111 and a wired communication interface 112.

The wireless communication interface 111 may include at least one wireless communication module, wireless communication circuitry, or wireless communication device for performing wireless communication with at least one external device.

For example, the communication interface 110 may include a short-range communication module such as an infrared (IR) communication module capable of receiving a control command from a remote control device (remote controller) located within a short distance. In this case, the communication interface 110 may receive a control signal from the remote control device.

In another example, the communication interface 110 may include at least one communication module for performing communication according to a wireless communication standard including Bluetooth, Wi-Fi, Bluetooth low energy (BLE), near-field communication (NFC)/radio frequency identification (RFID), Wi-Fi Direct, ultra-wideband (UWB), ZigBee, or the like. Alternatively, the communication interface 110 may further include a communication module for performing communication with a server for supporting long-range communication according to a long-range communication standard. For example, the communication interface 110 may include a communication module for performing communication via a network for Internet communication. In addition, the communication interface 110 may include a communication module for performing communication via a communication network that follows a communication standard such as 3^{rd}-generation (3G), 4^{th}-generation (4G), 5^{th}-generation (5G) and/or 6^{th}-generation (6G).

The wired communication interface 112 may include at least one port for connection to an external device via a wired cable so as to communicate with the external device by wire. For example, the wired communication interface 112 may include at least one of a HDMI port, a component jack, a PC port, or a USB port. Accordingly, the wired communication interface 112 may perform communication with an external device connected by wire via at least one port. In this regard, the port may refer to a physical hardware configuration into which a cable, a communication line, or a plug may be connected or inserted.

As described above, the communication interface 110 may include at least one support element for supporting communication between the first electronic device 100 and an external device. In this regard, the support element may include a communication module, communication circuitry, a communication device, a port for input/output of data, a cable port for input/output of data, a plug for input/output of data, or the like. For example, at least one support element included in the communication interface 110 may include an Ethernet communication module, a Wi-Fi communication module, a Bluetooth communication module, an IR communication module, a USB port, a tuner (or, broadcasting receiver), an HDMI port, a display port (DP), a digital visual interface (DVI) port, or the like.

The memory 120 may store a program for processing and controlling by the processor 130, and may store data input to the first electronic device 100 or data output from the first electronic device 100. In addition, the memory 120 may store a plurality of pieces of data required for operations of the first electronic device 100.

The memory 120 may include at least one type of storage medium from among a flash memory-type memory, a hard disk-type memory, a multimedia card micro-type memory, a card-type memory (for example, secure digital (SD) or extreme digital (XD) memory), random access memory (RAM), static RAM (SRAM), read-only memory (ROM), electrically erasable programmable ROM (EEPROM), programmable ROM (PROM), magnetic memory, a magnetic disk, and an optical disc.

The processor 130 includes processing circuitry, and may control all operations of the first electronic device 100. For example, the processor 130 may execute one or more instructions stored in the memory 120 to perform functions of the first electronic device 100 which are described in the disclosure.

In an embodiment of the disclosure, the processor 130 may store one or more instructions in an internal memory thereof, and may execute the one or more instructions stored in the internal memory to cause operations of a display device to be performed. In other words, the processor 130 may execute at least one instruction or program stored in an internal memory provided in the processor 130 or the memory 120 to perform a specified operation.

According to an embodiment of the disclosure, the processor 130 may execute the one or more instructions stored in the memory 120 to perform operations of the first electronic device 100 which are disclosed in the disclosure.

According to an embodiment of the disclosure, the processor 130 may execute the one or more instructions stored in the memory 120 to control a Wi-Fi/Bluetooth (BT) combo module (may also be referred to as Wi-Fi/Bluetooth (BT) combo interface in the present disclosure) to obtain a media access control (MAC) address of a standalone BT module (may also be referred to as standalone BT interface in the present disclosure), based on powering on of the first electronic device.

According to an embodiment of the disclosure, the processor 130 may execute the one or more instructions stored in the memory 120 to control the Wi-Fi/BT combo module to establish a connection according to Bluetooth communication with a second electronic device.

According to an embodiment of the disclosure, the processor 130 may execute the one or more instructions stored in the memory 120 to control the Wi-Fi/BT combo module to transmit the MAC address of the standalone BT module to the second electronic device via the Bluetooth communication connection between the Wi-Fi/BT combo module and the second electronic device and receive Wi-Fi connection information of the second electronic device.

According to an embodiment of the disclosure, the processor 130 may execute the one or more instructions stored in the memory 120 to control the standalone BT module to establish a connection according to Bluetooth communication with the second electronic device, based on the MAC address of the standalone BT module transmitted to the second electronic device.

According to an embodiment of the disclosure, the processor 130 may execute the one or more instructions stored in the memory 120 to control the Wi-Fi/BT combo module to establish a connection according to Wi-Fi communication with the second electronic device, based on the Wi-Fi connection information of the second electronic device received from the second electronic device.

According to an embodiment of the disclosure, the processor 130 may execute the one or more instructions stored in the memory 120 to control the Wi-Fi/BT combo module to transmit a request to the standalone BT module to enter a pairing mode, based on the powering on of the first electronic device.

According to an embodiment of the disclosure, the processor 130 may execute the one or more instructions stored in the memory 120 to control the Wi-Fi/BT combo module to transmit, to the second electronic device, a Bluetooth message including the MAC address of the standalone BT module.

According to an embodiment of the disclosure, the processor 130 may execute the one or more instructions stored in the memory 120 to receive, from the second electronic device, a connection request based on the Bluetooth communication with the standalone BT module, using the MAC address of the standalone BT module.

According to an embodiment of the disclosure, the processor 130 may execute the one or more instructions stored in the memory 120 to control the standalone BT module to perform a connection operation based on the Bluetooth communication with the second electronic device, in response to receiving the connection request.

According to an embodiment of the disclosure, the processor 130 may execute the one or more instructions stored in the memory 120 to control receiving of, from the second electronic device, a Bluetooth message including the Wi-Fi connection information of the second electronic device.

According to an embodiment of the disclosure, the processor 130 may execute the one or more instructions stored in the memory 120 to control the Wi-Fi/BT combo module to transmit, to the second electronic device, a connection request based on the Wi-Fi communication with the second electronic device, by using the Wi-Fi connection information of the second electronic device.

According to an embodiment of the disclosure, the processor 130 may execute the one or more instructions stored in the memory 120 to control the Wi-Fi/BT combo module to perform a connection operation based on the Wi-Fi communication with the second electronic device, based on the connection request.

According to an embodiment of the disclosure, the Wi-Fi connection information may include a service set identifier (SSID) and a password of a soft access point (AP) of the second electronic device.

According to an embodiment of the disclosure, the processor 130 may execute the one or more instructions stored in the memory 120 to control the standalone BT module to receive, from the second electronic device, a control signal related to power control of the first electronic device, according to the Bluetooth communication connection between the standalone BT module and the second electronic device.

According to an embodiment of the disclosure, the processor 130 may execute the one or more instructions stored in the memory 120 to control the Wi-Fi/BT combo module to transmit audio-visual data to the second electronic device, according to the Wi-Fi communication connection between the Wi-Fi/BT combo module and the second electronic device.

According to an embodiment of the disclosure, the processor 130 may execute the one or more instructions stored in the memory 120 to control the Wi-Fi/BT combo module to receive Wi-Fi communication-related state and/or control information from the second electronic device, according to the Bluetooth communication connection between the Wi-Fi/BT combo module and the second electronic device.

The first electronic device 100 may be any device including a processor and memory and configured to perform a function. The first electronic device 100 may be a stationary device or a portable device. For example, the first electronic device 100 may be a device for proving content to an external display device including a display. The content may include an image, a video, audio, text, a game, an application, or the like, but the disclosure is not limited thereto. The first electronic device 100 may include a set-top box (STB), a Blu-ray disc player, a digital versatile disc (DVD) player, a game console, a digital camera, a camcorder, a streaming device, a home theater, or the like. The first electronic device 100 may be referred to as a source device as it provides content, and may also be referred to as a content providing device, an electronic device, a computing device, or the like.

A block diagram of the first electronic device 100 shown in FIG. 2 is a block diagram for an embodiment of the disclosure. Each element of the block diagram may be combined, added, or omitted according to actual specification of the first electronic device 100. For example, when required, two or more elements may be combined into one element, or one element may be divided into two or more elements. In addition, a function performed by each block may be for descriptions of embodiments of the disclosure, and particular operations or devices therefor do not limit the scope of the disclosure.

The second electronic device 200 may include a communication interface 210, memory 220, and a processor 230.

The communication interface 210 may include communication circuitry and may perform communication with at least one external device. In this regard, the “communication” may refer to an operation of transmitting and/or receiving data, a signal, a request, and/or a command. The communication interface 210 may perform wired or wireless communication with at least one external device. An external device may be the first electronic device 100. For example, the communication interface 210 may include at least one of a communication module, communication circuitry, a communication device, an input/output port, or an input/output plug for performing wired or wireless communication with at least one external device.

The communication interface 210 may include a wireless communication interface 211 and a wired communication interface 212.

The wireless communication interface 211 may include at least one wireless communication module, wireless communication circuitry, or wireless communication device for performing wireless communication with at least one external device.

For example, the communication interface 210 may include a short-range communication module such as an IR communication module capable of receiving a control command from a remote control device (remote controller) located within a short distance. In this case, the communication interface 210 may receive a control signal from the remote control device.

In another example, the wireless communication interface 211 may include at least one communication module for performing communication according to a wireless communication standard including Bluetooth, Wi-Fi, BLE, NFC/RFID, Wi-Fi Direct, UWB, ZigBee, or the like. Alternatively, the wireless communication interface 211 may further include a communication module for performing communication with a server for supporting long-range communication according to a long-range communication standard. For example, the wireless communication interface 211 may include a communication module for performing communication via a network for Internet communication. In addition, the wireless communication interface 211 may include a communication module for performing communication via a communication network that follows a communication standard such as 3^{rd}-generation (3G), 4^{th}-generation (4G), 5^{th}-generation (5G) and/or 6^{th}-generation (6G).

The wired communication interface 212 may include at least one port for connection to an external device via a wired cable so as to communicate with the external device by wire. For example, the wired communication interface 212 may include at least one of an HDMI port, a component jack, a PC port, or a USB port. Accordingly, the wired communication interface 212 may perform communication with an external device connected by wire via at least one port. In this regard, the port may refer to a physical hardware configuration into which a cable, a communication line, or a plug may be connected or inserted.

As described above, the communication interface 210 may include at least one support element for supporting communication between the second electronic device 200 and an external device. In this regard, the support element may include a communication module, communication circuitry, a communication device, a port for input/output of data, a cable port for input/output of data, a plug for input/output of data, or the like. For example, at least one support element included in the communication interface 210 may include an Ethernet communication module, a Wi-Fi communication module, a Bluetooth communication module, an IR communication module, a USB port, a tuner (or, broadcasting receiver), an HDMI port, a DP, a DVI port, or the like.

The memory 220 may store a program for processing and controlling by the processor 230, and may store data input to the second electronic device 200 or data output from the second electronic device 200. In addition, the memory 220 may store a plurality of pieces of data required for operations of the second electronic device 200.

The memory 220 may include at least one type of storage medium from among a flash memory-type memory, a hard disk-type memory, a multimedia card micro-type memory, a card-type memory (for example, SD or XD memory), RAM, SRAM, ROM, EEPROM, PROM, magnetic memory, a magnetic disk, and an optical disc.

The processor 230 includes processing circuitry, and may control all operations of the second electronic device 200. For example, the processor 230 may execute one or more instructions stored in the memory 220 to perform functions of the second electronic device 200 which are described in the disclosure.

In an embodiment of the disclosure, the processor 230 may store one or more instructions in an internal memory thereof, and may execute the one or more instructions stored in the internal memory to cause operations of a display device to be performed. In other words, the processor 230 may execute at least one instruction or program stored in an internal memory provided in the processor 230 or the memory 220 to perform a specified operation.

According to an embodiment of the disclosure, the processor 230 may execute the one or more instructions stored in the memory 220 to perform operations of the second electronic device 200 which are disclosed in the disclosure.

According to an embodiment of the disclosure, the processor 230 may execute the one or more instructions stored in the memory 220 to control the Wi-Fi/BT combo module to establish a connection according to Bluetooth communication, in response to receiving a Bluetooth advertising packet from a first electronic device.

According to an embodiment of the disclosure, the processor 230 may execute the one or more instructions stored in the memory 220 to control the Wi-Fi/BT combo module to receive a MAC address of the standalone BT module of the first electronic device from the first electronic device via the Bluetooth communication connection between the Wi-Fi/BT combo module and the first electronic device and transmit Wi-Fi connection information of the second electronic device to the first electronic device.

According to an embodiment of the disclosure, the processor 230 may execute the one or more instructions stored in the memory 220 to control the standalone BT module to establish a connection according to Bluetooth communication with the first electronic device, based on the MAC address of the standalone BT module of the first electronic device.

According to an embodiment of the disclosure, the processor 230 may execute the one or more instructions stored in the memory 220 to control the Wi-Fi/BT combo module to establish a connection according to Wi-Fi communication with the first electronic device, based on the Wi-Fi connection information of the second electronic device.

According to an embodiment of the disclosure, the processor 230 may execute the one or more instructions stored in the memory 220 to control the Wi-Fi/BT combo module to receive a Bluetooth message including the MAC address of the standalone BT module of the first electronic device.

According to an embodiment of the disclosure, the processor 230 may execute the one or more instructions stored in the memory 220 to control the standalone BT module to transmit, to the first electronic device, a connection request based on the Bluetooth communication with the first electronic device, using the MAC address of the standalone BT module of the first electronic device.

According to an embodiment of the disclosure, the processor 230 may execute the one or more instructions stored in the memory 220 to control the standalone BT module to perform a connection operation based on the Bluetooth communication with the first electronic device, in response to transmitting the connection request.

According to an embodiment of the disclosure, the processor 230 may execute the one or more instructions stored in the memory 220 to control the Wi-Fi/BT combo module to transmit, to the first electronic device, a Bluetooth message including the Wi-Fi connection information of the second electronic device, the Wi-Fi connection information corresponding to a wireless network generated for a Soft AP.

According to an embodiment of the disclosure, the processor 230 may execute the one or more instructions stored in the memory 220 to control the Wi-Fi/BT combo module to receive, from the first electronic device, a connection request based on the Wi-Fi connection information of the second electronic device.

According to an embodiment of the disclosure, the processor 230 may execute the one or more instructions stored in the memory 220 to control the Wi-Fi/BT combo module to perform a connection operation based on the Wi-Fi communication with the first electronic device, based on the connection request.

The second electronic device 200 may be any device including a processor and memory and configured to perform a function. The second electronic device 200 may be a stationary device or a portable device. For example, the second electronic device 200 may indicate a device including a display and configured to display image content, video content, game content, graphic content, etc. The second electronic device 200 may include, for example, any type of electronic device capable of receiving and outputting content, for example, a TV such as a network TV, a smart TV, an Internet TV, a web TV, or an Internet protocol (IP) TV, a computer such as a desktop computer, a laptop computer, or a tablet computer, or a smart device such as a smartphone, a cellular phone, a game player, a music player, a vide player, a medical device, or a home appliance. The second electronic device 200 may be referred to as a sink device as it receives data from the first electronic device 100, and may also be referred to as a computing device, a content receiver, a Bluetooth communication device, or the like.

A block diagram of the second electronic device 200 shown in FIG. 2 is a block diagram for an embodiment of the disclosure. Each element of the block diagram may be combined, added, or omitted according to actual specification of the second electronic device 200. For example, when required, two or more elements may be combined into one element, or one element may be divided into two or more elements. In addition, a function performed by each block may be for descriptions of embodiments of the disclosure, and particular operations or devices therefor do not limit the scope of the disclosure.

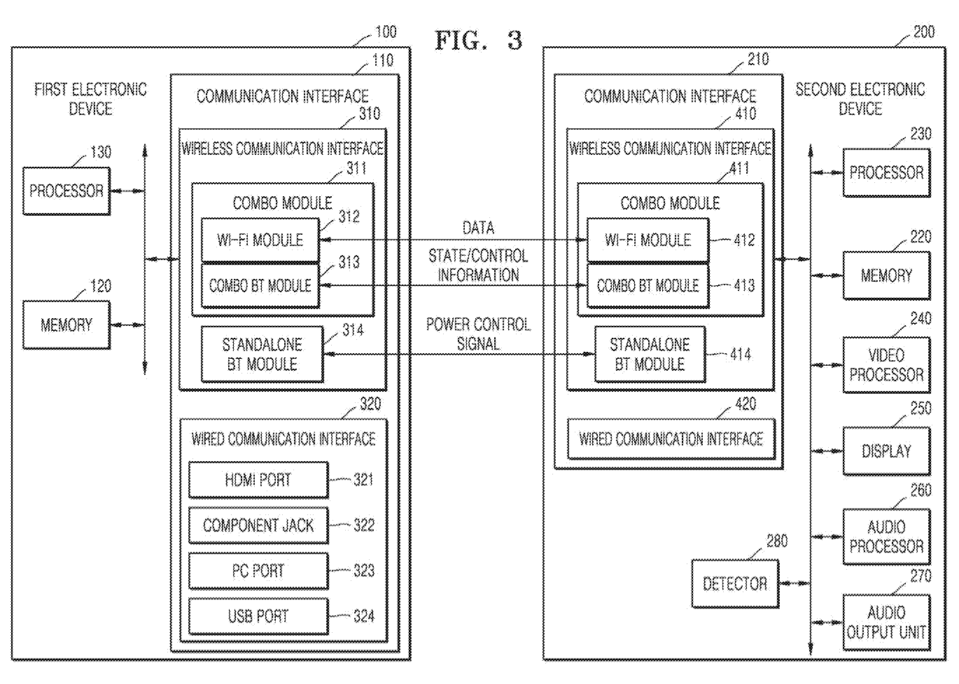

FIG. 3 illustrates a detailed block diagram of a first electronic device and a second electronic device, according to an embodiment of the disclosure.

The first electronic device 100 may include the communication interface 110, the memory 120, and the processor 130.

The communication interface 110 may include a wireless communication interface 310 and a wired communication interface 320.

The wireless communication interface 310 may include one or more modules that enable wireless communication between the first electronic device 100 and a wireless communication system or between the first electronic device 100 and a network in which another electronic device is located.

The wireless communication interface 310 may include a combined Wi-Fi and BT interface or Wi-Fi/BT combo module 311 and a standalone BT module or interface 314.

The Wi-Fi/BT combo module 311 is a module that integrates a Wi-Fi module 312 and a combo BT module 313, and may be referred to as a Wi-Fi BT integrated module. The Wi-Fi/BT combo module 311 refers to a wireless communication semiconductor that integrates Wi-Fi and Bluetooth functions into a single silicon chip. This is intended to efficiently provide wireless connection in various electronic devices such as smartphones, tablet computers, laptop computers, Internet of Things (IoT) devices, etc. Because Wi-Fi and Bluetooth share a 2.4 GHz frequency band, a combo chip is designed to allow the two technologies to operate without interfering with each other. The Wi-Fi module complies with the IEEE 802.11 standard and may mainly support 2.4 GHz and 5 GHz (or 6 GHz) bands. The Bluetooth module may support the latest standards such as Bluetooth 5.0/5.1/5.2/5.3, etc. As such, by integrating Wi-Fi and Bluetooth into a single chip, space may be saved to enable ultra-compact packaging, and the two wireless systems may be efficiently managed to extend battery lifespan, thereby reducing power consumption. The Wi-Fi/BT combo module 311 may be referred to as a combo module 311.

The Wi-Fi module 312 may establish a communication connection with the second electronic device 200 according to a Wi-Fi communication protocol and may perform communication, under control by the processor 130.

According to an embodiment of the disclosure, the Wi-Fi module 312 may establish a communication connection according to a Wi-Fi communication protocol with a Wi-Fi module 412 of the second electronic device 200, according to powering on of the first electronic device 100.

According to an embodiment of the disclosure, the Wi-Fi module 312 may establish a communication connection according to a Wi-Fi communication protocol with the Wi-Fi module 412 of the second electronic device 200 by using Wi-Fi connection information received from the second electronic device 200.

According to an embodiment of the disclosure, the Wi-Fi module 312 may transmit data, for example, audio-visual data, to the Wi-Fi module 412 of the second electronic device 200 when the communication connection according to the Wi-Fi communication protocol of the second electronic device 200 is established with the first electronic device 100.

The combo BT module 313 may establish a communication connection according to a Bluetooth communication protocol with the second electronic device 200 and may perform communication, under control by the processor 130. The Bluetooth communication protocol may include a classic Bluetooth communication protocol or a BLE communication protocol.

According to an embodiment of the disclosure, the combo BT module 313 may establish a communication connection according to a Bluetooth communication protocol with a combo BT module 413 of the second electronic device 200, according to the powering on of the first electronic device 100.

According to an embodiment of the disclosure, the combo BT module 313 may obtain a MAC address of the standalone BT module 314 and request the standalone BT module 314 to enter a pairing mode, according to the powering on of the first electronic device 100.

According to an embodiment of the disclosure, the combo BT module 313 may broadcast a BLE advertising packet to enable discovery of the first electronic device 100 by the second electronic device 200, according to the powering on of the first electronic device 100.

According to an embodiment of the disclosure, the combo BT module 313 may transmit the MAC address of the standalone BT module 314 to the second electronic device 200 according to the establishment of the Bluetooth connection with the combo BT module 413 of the second electronic device 200.

According to an embodiment of the disclosure, the combo BT module 313 may receive, from the second electronic device 200, Wi-Fi connection information for connection to a Soft AP of the second electronic device 200, according to the establishment of the Bluetooth connection with the combo BT module 413 of the second electronic device 200.

According to an embodiment of the disclosure, the combo BT module 313 may be responsible for at least one of Wi-Fi communication-related state information or Wi-Fi communication-related control information, according to the establishment of the Bluetooth connection with the combo BT module 413 of the second electronic device 200. The combo BT module 313 may receive at least one of the Wi-Fi communication-related state information or the Wi-Fi communication-related control information from the combo BT module 413 of the second electronic device 200. The Wi-Fi communication-related state information may include information such as a connection state of Wi-Fi communication or the strength of a Wi-Fi signal. For example, the Wi-Fi communication-related state information may include a state indicating that Wi-Fi is connected, a state indicating that Wi-Fi is not connected, or the strength of a Wi-Fi signal. The Wi-Fi communication-related control information may include a control signal instructing Wi-Fi connection or a control signal instructing Wi-Fi disconnection.

The standalone BT module 314 refers to an independent module having a built-in BLE communication function. The term “standalone” is used to denote a BT module that exists independently, unlike a combo module in which a Wi-Fi module and a Bluetooth module are integrated.

According to an embodiment of the disclosure, the standalone BT module 314 may provide the MAC address of the standalone BT module 314 to the combo BT module 313 in response to a request from the combo BT module 313, according to the powering on of the first electronic device 100.

According to an embodiment of the disclosure, the standalone BT module 314 may receive a request for entering the pairing mode from the combo BT module 313, according to the powering on of the first electronic device 100, and accordingly, may enter the pairing mode.

According to an embodiment of the disclosure, the standalone BT module 314 may receive, from the standalone BT module 414 of the second electronic device 200, a connection request according to the Bluetooth communication, and accordingly, may establish a connection according to the Bluetooth communication.

According to an embodiment of the disclosure, the standalone BT module 314 may receive a power control-related control signal from the second electronic device 200, according to the establishment of the Bluetooth communication connection with the standalone BT module 414 of the second electronic device 200. The power control-related control signal may include a control signal for turning on/off power of the first electronic device 100.

According to an embodiment of the disclosure, the power control-related control signal may include a power-on signal. For example, when the second electronic device 200 is powered on according to a user input, the second electronic device 200 may transmit, to the first electronic device 100, a control signal for powering on the first electronic device 100 connected to the second electronic device 200. In other words, the standalone BT module 314 of the first electronic device 100 may receive a power-on signal from the standalone BT module 414 of the second electronic device 200. Accordingly, when the standalone BT module 314 of the first electronic device 100 receives the power-on signal, the standalone BT module 314 may wake up a processor of the first electronic device 100 that has been in a low-power state or a power-off state, thereby powering on the first electronic device 100.

According to an embodiment of the disclosure, the power control-related control signal may include a power-off related state signal. In other words, the standalone BT module 314 of the first electronic device 100 may receive a power-off related state signal from the standalone BT module 414 of the second electronic device 200. The power-off related state signal may include, for example, a suspend state signal or a normal state signal. For example, when the second electronic device 200 is powered off, the second electronic device 200 may transmit a suspend state signal to the first electronic device 100 connected to the second electronic device 200. The first electronic device 100 that has received the suspend state signal may enter a suspend state. The suspend state may include the first electronic device 100 entering a lower-power mode or operating in a power-off mode. For example, when only a display screen of the second electronic device 200 is powered off while a processor of the second electronic device 200 operates in a normal state, the second electronic device 200 may transmit a normal state signal to the first electronic device 100 connected to the second electronic device 200. The first electronic device 100 that has received the normal state signal may maintain a normal state in which the first electronic device 100 operates normally. In other words, when only the display screen of the second electronic device 200 is turned off, the first electronic device 100 may maintain the normal state in which the first electronic device 100 operates normally.

The wired communication interface 320 may include one of an HDMI port 321, a component jack 322, a PC port 323, and a USB port 324, or may include a combination thereof. The wired communication interface 320 may further include a DP, a Thunderbolt port, a mobile high-definition link (MHL), as well as the HDMI port 321.

The second electronic device 200 may include a video processor 240, a display 250, an audio processor 260, an audio output unit 270, and a detector 280, as well as the communication interface 210, the memory 220, and the processor 230. The communication interface 210 may include wireless communication interface 410 and wired communication interface 420.

A wireless communication interface 410 may include one or more modules that enable wireless communication between the second electronic device 200 and a wireless communication system or between the second electronic device 200 and a network in which another electronic device is located.

The wireless communication interface 410 may include a Wi-Fi/BT combo module 411 and the standalone BT module 414.

The Wi-Fi/BT combo module 411 is a module that integrates the Wi-Fi module 412 and the combo BT module 413, and may be referred to as a Wi-Fi BT integrated module. The Wi-Fi/BT combo module 411 refers to a wireless communication semiconductor that integrates Wi-Fi and Bluetooth functions into a single silicon chip. This is intended to efficiently provide wireless connection in various electronic devices such as smartphones, tablet computers, laptop computers, IoT devices, etc. Because Wi-Fi and Bluetooth share a 2.4 GHz frequency band, a combo chip is designed to allow the two technologies to operate without interfering with each other. The Wi-Fi module 412 complies with the IEEE 802.11 standard and may mainly support 2.4 GHz and 5 GHz (or 6 GHz) bands. The Bluetooth module may support the latest standards such as Bluetooth 5.0/5.1/5.2/5.3, etc. As such, by integrating Wi-Fi and Bluetooth into a single chip, space may be saved to enable ultra-compact packaging, and the two wireless systems may be efficiently managed to extend battery lifespan, thereby reducing power consumption. The Wi-Fi/BT combo module 411 may be referred to as a combo module 411.

The Wi-Fi module 412 may establish a communication connection with the first electronic device 100 according to a Wi-Fi communication protocol and may perform communication, under control by the processor 230.

The Wi-Fi module 412 may establish a communication connection with the first electronic device 100 according to a Wi-Fi communication protocol and may perform communication, under control by the processor 230.

According to an embodiment of the disclosure, the Wi-Fi module 412 may establish a communication connection according to a Wi-Fi communication protocol with the Wi-Fi module 312 of the first electronic device 100.

According to an embodiment of the disclosure, the Wi-Fi module 412 may configure a wireless network for a Soft AP to establish a Wi-Fi communication connection with the first electronic device 100.

According to an embodiment of the disclosure, the Wi-Fi module 412 may provide, to the Wi-Fi module 312 of the first electronic device 100, Wi-Fi connection information for connection to a wireless network configured according to the configuration of the wireless network for the Soft AP. In this case, the Wi-Fi connection information may include an SSID and a password of the Soft AP. The Wi-Fi connection information may be transmitted to the first electronic device 100 via a BLE message.

According to an embodiment of the disclosure, the Wi-Fi module 412 may receive data, for example, audio-visual data, to the Wi-Fi module 312 of the first electronic device 100 when the communication connection according to the Wi-Fi communication protocol of the second electronic device 200 is established with the first electronic device 100.

The combo BT module 413 may establish a communication connection according to a Bluetooth communication protocol with the first electronic device 100 and may perform communication, under control by the processor 230.

According to an embodiment of the disclosure, the combo BT module 413 may establish a communication connection according to a Bluetooth communication protocol with the combo BT module 313 of the first electronic device 100, according to powering on of the first electronic device 100.

According to an embodiment of the disclosure, the combo BT module 413 may perform a BLE scan operation for discovery of a peripheral device, and accordingly, may receive a BLE advertising packet broadcast from the first electronic device 100. In this case, the BLE scan operation for the discovery of the peripheral device may be triggered according to a user input.

According to an embodiment of the disclosure, the combo BT module 413 may identify the first electronic device 100 in response to receiving the BLE advertising packet, may transmit a connection request to the combo BT module 313 of the identified first electronic device 100 and correspondingly receive a connection acceptance notification from the combo BT module 313 of the first electronic device 100, and thus, may perform a connection operation according to Bluetooth communication with the combo BT module 313 of the first electronic device 100.

According to an embodiment of the disclosure, the combo BT module 413 may receive a MAC address of the standalone BT module 314 of the first electronic device 100 from the combo BT module 313 of the first electronic device 100, according to the establishment of the Bluetooth connection with the combo BT module 313 of the first electronic device 100.

According to an embodiment of the disclosure, the combo BT module 413 may transmit, to the first electronic device 100, Wi-Fi connection information for connection to a Soft AP of the second electronic device 200, according to the establishment of the Bluetooth connection with the combo BT module 313 of the first electronic device 100.

According to an embodiment of the disclosure, the combo BT module 413 may be responsible for at least one of Wi-Fi communication-related state information or Wi-Fi communication-related control information, according to the establishment of the Bluetooth connection with the combo BT module 313 of the first electronic device 100. The combo BT module 413 may transmit at least one of the Wi-Fi communication-related state information or the Wi-Fi communication-related control information to the combo BT module 313 of the first electronic device 100. The Wi-Fi communication-related state information may include information such as a connection state of Wi-Fi communication or the strength of a Wi-Fi signal. For example, the Wi-Fi communication-related state information may include a state indicating that Wi-Fi is connected, a state indicating that Wi-Fi is not connected, or the strength of a Wi-Fi signal. The Wi-Fi communication-related control information may include a control signal instructing Wi-Fi connection or a control signal instructing Wi-Fi disconnection.

The standalone BT module 414 refers to an independent module having a built-in BLE communication function.

According to an embodiment of the disclosure, the standalone BT module 414 may receive the MAC address of the standalone BT module 314 of the first electronic device 100 from the combo BT module 413.

According to an embodiment of the disclosure, the standalone BT module 414 may receive a connection request according to the Bluetooth communication with the standalone BT module 314 of the first electronic device 100, using the MAC address of the standalone BT module 314 of the first electronic device 100, and accordingly, may establish a connection according to the Bluetooth communication with the standalone BT module 314 of the first electronic device 100, in response to receiving a connection acceptance notification from the standalone BT module 314 of the first electronic device 100.

According to an embodiment of the disclosure, the standalone BT module 414 may transmit a power control-related control signal to the first electronic device 100, according to the establishment of the Bluetooth communication connection with the standalone BT module 314 of the first electronic device 100. The power control-related control signal may include a control signal for turning on/off power of the first electronic device 100.

According to an embodiment of the disclosure, the wired communication interface 420 may include one of an HDMI port, a component jack, a PC port, and a USB port, or may include a combination thereof. The wired communication interface 420 may further include a DP, a Thunderbolt port, a mobile high-definition link (MHL), as well as the HDMI port.

According to an embodiment of the disclosure, the power control-related control signal may include a power-on signal. For example, when the second electronic device 200 is powered on according to a user input, the second electronic device 200 may transmit, to the first electronic device 100, a control signal for powering on the first electronic device 100 connected to the second electronic device 200. In other words, the standalone BT module 414 of the second electronic device 200 may transmit a power-on signal to the standalone BT module 314 of the first electronic device 100.

According to an embodiment of the disclosure, the power control-related control signal may include a power-off related state signal. In other words, the standalone BT module 414 of the second electronic device 200 may transmit a power-off related state signal to the standalone BT module 314 of the first electronic device 100. For example, when the second electronic device 200 is powered off, the second electronic device 200 may transmit a suspend state signal to the first electronic device 100 connected to the second electronic device 200. The first electronic device 100 that has received the suspend state signal may enter a suspend state. The suspend state may include the first electronic device 100 entering a lower-power mode or operating in a power-off mode. For example, when only a display screen of the second electronic device 200 is powered off while a processor of the second electronic device 200 operates in a normal state, the second electronic device 200 may transmit a normal state signal to the first electronic device 100 connected to the second electronic device 200. The first electronic device 100 that has received the normal state signal may maintain a normal state in which the first electronic device 100 operates normally.

As shown in FIG. 3, the combo BT module 313 and the combo BT module 413 may be provided for Wi-Fi communication-related control signal transmission/reception between the first electronic device 100 and the second electronic device 200, and the standalone BT module 314 and the standalone BT module 414 may be provided for power control signal transmission/reception between the first electronic device 100 and the second electronic device 200, thereby enabling more reliable processing of power control signal transmission/reception.

The video processor 240 may process a video signal received from the communication interface 210 and may output the video signal to the display 250, under control by the processor 230.

The display 250 may display the video signal on a screen.

The audio processor 260 may convert an audio signal received from the communication interface 210 into an analog audio signal and may output the analog audio signal to the audio output unit 270, under control by the processor 230.

The audio output unit 270 may output audio (for example, a voice or sound) input via the communication interface 210. In addition, the audio output unit 270 may output audio stored in the memory 220, under control by the processor 230. The audio output unit 270 may include at least one of a speaker, a headphone output terminal, or a Sony/Philips digital interface (S/PDIF) output terminal or a combination thereof.

The detector 280 detects speech of a user, a video of the user, or an interaction of the user, and may include a microphone 281, a camera 282, and a light receiver 283.

The microphone 281 receives speech uttered by the user. The microphone 281 may convert the received speech into an electric signal and output the electric signal to the processor 230. The user’s speech may include, for example, speech corresponding to a menu or function of the second electronic device 200.

The camera 282 may receive a video (for example, consecutive frames) corresponding to motion of a user including a gesture within a camera recognition range. The processor 230 may select a menu displayed on the second electronic device 200 by using a received motion recognition result or may perform control corresponding to the motion recognition result.

The light receiver 283 receives an optical signal (including the control signal) received from an external control device. The light receiver 283 may receive an optical signal corresponding to a user input (for example, touch, press, touch gesture, speech, or motion) from a control device. The control signal may be extracted from the received optical signal, under control by the processor 230.

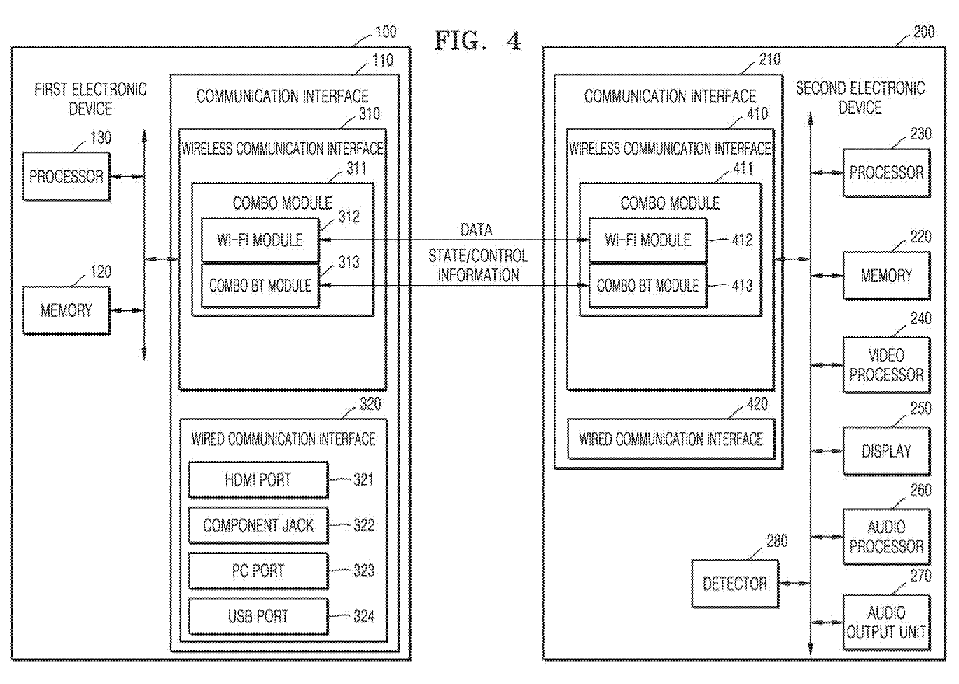

FIG. 4 is a block diagram of a first electronic device and a second electronic device, according to an embodiment of the disclosure.

Referring to FIG. 4, the configuration is mostly the same as that illustrated in FIG. 3, except that the wireless communication interface 310 of the first electronic device 100 of FIG. 4 does not include the standalone BT module 314, and the wireless communication interface 410 of the second electronic device 200 of FIG. 4 does not include the standalone BT module 414.

In the example illustrated in FIG. 3, the standalone BT module 314 and the standalone BT module 414 are separately provided for power control signal transmission/reception between the first electronic device 100 and the second electronic device 200. In contrast, in the example illustrated in FIG. 4, the combo BT module 313 of the combo module 311 and the combo BT module 413 of the combo module 411 may be responsible for power control signal transmission/reception between the first electronic device 100 and the second electronic device 200. In other words, in the example illustrated in FIG. 4, the combo BT module 313 of the first electronic device 100 and the combo BT module 413 of the second electronic device 200 may be responsible for not only transmission/reception of Wi-Fi communication-related state information or Wi-Fi communication-related control information but also power control signal transmission/reception. As shown in FIG. 3, in a case where the standalone BT module 314 and the standalone BT module 414 are separately provided for power control signal transmission/reception between the first electronic device 100 and the second electronic device 200, power control signal transmission/reception may be processed more reliably. In contrast, as in the example illustrated in FIG. 4, in a case where the combo BT module 313 of the first electronic device 100 and the combo BT module 413 of the second electronic device 200 are responsible for not only transmission/reception of Wi-Fi communication-related state information or Wi-Fi communication-related control information but also power control signal transmission/reception, a communication chip may be configured more concisely and efficiently.

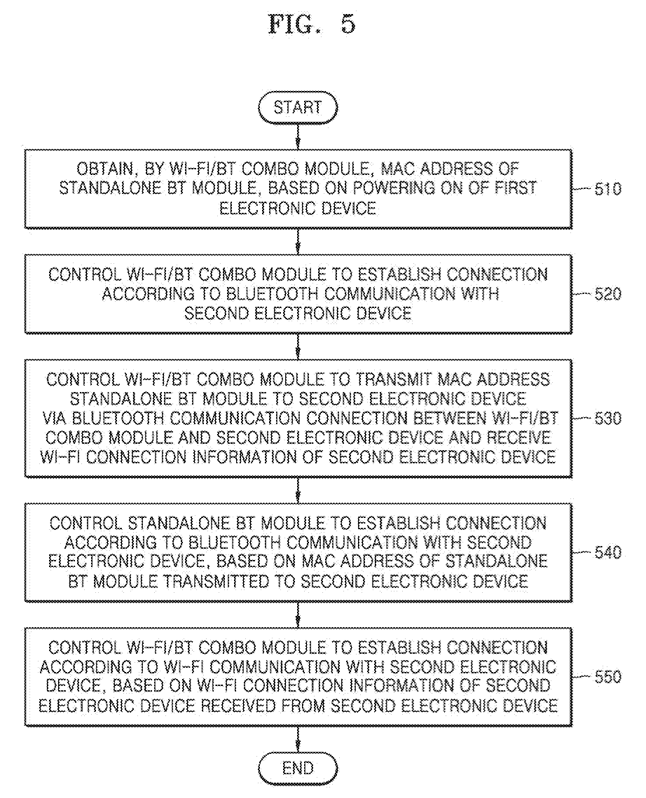

FIG. 5 is a flowchart of an operating method of a first electronic device, according to an embodiment of the disclosure.

Referring to FIG. 5, in operation 510, the Wi-Fi/BT combo module 311 may obtain a MAC address of the standalone BT module 314, based on powering on of the first electronic device 100.

According to an embodiment of the disclosure, when the first electronic device 100 is powered on, the first electronic device 100 may automatically perform an operation for wirelessly connecting the first electronic device 100 and the second electronic device 200 for communication therebetween, that is, the operation illustrated in FIG. 5. In addition, the first electronic device 100 may control the Wi-Fi/BT combo module 311 to obtain the MAC address of the standalone BT module 314 and may control the standalone BT module 314 to operate in a pairing mode, to initiate the wireless communication connection operation. In BLE communication, the MAC address refers to a 48-bit address that uniquely identifies a BLE module on a network. The MAC address is a unique identifier assigned to a network interface, and each device within a BLE network may be distinguished by its unique MAC address. A BLE device may cause its MAC address to be included in an advertising packet to announce its presence to a peripheral device.

According to an embodiment of the disclosure, the first electronic device 100 may be powered on during an out-of-box experience (OOBE) stage. OOBE refers to an initial experience in which a user first unpacks and uses a purchased product, and in the OOBE stage, when the first electronic device 100 is powered on, operation 510 may be initiated.

According to an embodiment of the disclosure, even in a state in which the first electronic device 100 is already in use by a user, when power of the first electronic device 100 is turned off and then turned on again for a reset, etc., the first electronic device 100 may be powered on. The operation 510 may be initiated when the power-on is caused by the reset.

In operation 520, the Wi-Fi/BT combo module 311 of the first electronic device 100 may control establishing of a connection according to Bluetooth communication with the second electronic device 200.

According to an embodiment of the disclosure, when the first electronic device 100 is powered on, the first electronic device 100 may broadcast an advertising packet to notify peripheral devices of its presence. A BLE advertising packet is a data packet that a BLE device periodically transmits to notify its surroundings of its presence and key information. The advertising packet serves as an initial signal for a connection request and allows the first electronic device 100 to broadcast its information while in a low-power state.

According to an embodiment of the disclosure, the combo BT module 313 of the Wi-Fi/BT combo module 311 of the first electronic device 100 may broadcast a BLE advertising packet. The BLE advertising packet may include a MAC address of the combo BT module 313 and a device name of the first electronic device 100. The second electronic device 200 may receive the BLE advertising packet broadcast from the first electronic device 100 by periodically scanning peripheral devices, and may identify the first electronic device 100 from the received BLE advertising packet. Afterwards, the first electronic device 100 may receive a connection request from the second electronic device 200 and correspondingly transmit a connection acceptance notification to the second electronic device 200, and thus, the Wi-Fi/BT combo module 311 of the first electronic device 100 may establish the Bluetooth connection with the second electronic device 200.

In operation 530, the Wi-Fi/BT combo module 311 may transmit the MAC address of the standalone BT module 314 to the second electronic device 200 via the Bluetooth communication connection between the Wi-Fi/BT combo module 311 of the first electronic device 100 and the second electronic device 200, and may receive Wi-Fi connection information of the second electronic device 200.

According to an embodiment of the disclosure, the Wi-Fi/BT combo module 311 of the first electronic device 100 may cause the MAC address of the standalone BT module 314 to be included in a message based on the Bluetooth communication connection, and may transmit the message to the second electronic device 200. For example, the Wi-Fi/BT combo module 311 of the first electronic device 100 may cause the MAC address of the standalone BT module 314 to be included in a state report according to the Bluetooth communication connection, and may transmit the state report to the second electronic device 200. As such, by causing the MAC address of the standalone BT module 314 of the first electronic device 100 to be included in a BLE message and transmitting the BLE message, time required for establishing a standalone BLE connection may be reduced.

According to an embodiment of the disclosure, the Wi-Fi/BT combo module 311 of the first electronic device 100 may receive, from the second electronic device 200, a message including the Wi-Fi connection information of the second electronic device 200, based on the Bluetooth communication connection. The Wi-Fi connection information refers to settings information that is used when the first electronic device 100 accesses a wireless network of the second electronic device 200, and may include, for example, an SSID and a password. As such, by receiving the Wi-Fi connection information of the second electronic device 200 for a Wi-Fi communication connection via a BLE message, time required for establishing a Wi-Fi connection may be reduced.

In operation 540, the first electronic device 100 may control the standalone BT module 314 to establish a connection according to the Bluetooth communication with the second electronic device 200, based on the MAC address of the standalone BT module 314 transmitted to the second electronic device 200.

According to an embodiment of the disclosure, the second electronic device 200 may obtain the MAC address of the standalone BT module 314 of the first electronic device 100, the second electronic device 200 may transmit a connection request to the first electronic device 100 by using the MAC address of the standalone BT module 314, and the standalone BT module 314 of the first electronic device 100 that has received the connection request may then perform a BLE connection operation with the second electronic device 200.

In operation 550, the first electronic device 100 may control the Wi-Fi/BT combo module 311 to establish a connection according to Wi-Fi communication with the second electronic device 200, based on the Wi-Fi connection information of the second electronic device 200 received from the second electronic device 200.

According to an embodiment of the disclosure, the Wi-Fi/BT combo module 311 of the first electronic device 100 may transmit a Wi-Fi connection request to the second electronic device 200, based on the Wi-Fi connection information of the second electronic device 200 received from the second electronic device 200, and the Wi-Fi/BT combo module 311 may establish a connection according to the Wi-Fi communication with the second electronic device 200, based on the Wi-Fi connection request.

In the embodiment of the disclosure illustrated in FIG. 5, it has been described that the MAC address of the standalone BT module 314 of the first electronic device 100 is transmitted by being included in the BLE message transmitted by the combo module 311, but the disclosure is not limited thereto. It is possible to transmit the MAC address of the standalone BT module 314 of the first electronic device 100 by being included in the BLE advertising packet broadcast by the combo module 311.

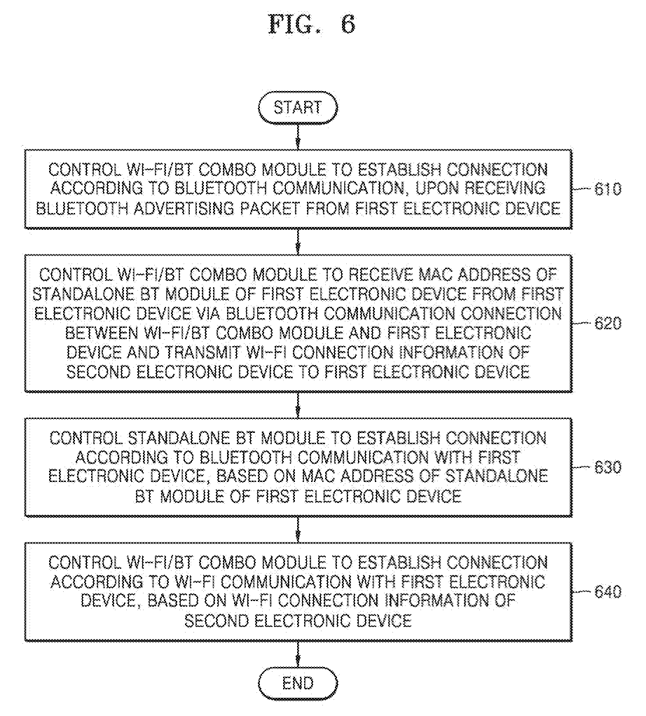

FIG. 6 is a flowchart of an operating method of a second electronic device, according to an embodiment of the disclosure.

Referring to FIG. 6, in operation 610, the second electronic device 200 may control the Wi-Fi/BT combo module 411 to establish a connection according to Bluetooth communication, in response to receiving a Bluetooth advertising packet from the first electronic device 100.

According to an embodiment of the disclosure, the Wi-Fi/BT combo module 411 of the second electronic device 200 may receive an advertising packet from the first electronic device 100 by monitoring advertising channels to search for BLE devices present around the second electronic device 200. The Wi-Fi/BT combo module 411 of the second electronic device 200 may obtain the MAC address of the standalone BT module 314 of the first electronic device 100 from the advertising packet of the first electronic device 100. The Wi-Fi/BT combo module 411 of the second electronic device 200 may perform a connection operation with the first electronic device 100 by transmitting a connection request to the first electronic device 100 and receiving a connection acceptance notification in response to the connection request.

In operation 620, the second electronic device 200 may control the Wi-Fi/BT combo module 411 to receive a MAC address of the standalone BT module 314 of the first electronic device 100 from the first electronic device 100 via the Bluetooth communication connection between the Wi-Fi/BT combo module 411 and the first electronic device 100 and transmit Wi-Fi connection information of the second electronic device 200 to the first electronic device 100.

According to an embodiment of the disclosure, the Wi-Fi/BT combo module 411 of the second electronic device 200 may receive a message including the MAC address of the standalone BT module 314 of the first electronic device 100 from the first electronic device 100, based on the Bluetooth communication connection. For example, the Wi-Fi/BT combo module 411 of the second electronic device 200 may receive a state report including the MAC address of the standalone BT module 314 of the first electronic device 100 from the first electronic device 100, according to the Bluetooth communication connection. As such, by causing the MAC address of the standalone BT module 314 of the first electronic device 100 to be included in a BLE message and transmitting the BLE message, time required for establishing a standalone BLE connection may be reduced.

According to an embodiment of the disclosure, the Wi-Fi/BT combo module 411 of the second electronic device 200 may transmit a message including the Wi-Fi connection information of the second electronic device 200 to the first electronic device 100, based on the Bluetooth communication connection. The Wi-Fi connection information refers to settings information that is used when the first electronic device 100 accesses a wireless network of the second electronic device 200, and may include, for example, an SSID and a password. As such, by transmitting the Wi-Fi connection information of the second electronic device 200 for a Wi-Fi communication connection via a BLE message, time required for establishing a Wi-Fi connection may be reduced.

In operation 630, the second electronic device 200 may control the standalone BT module 414 to establish a connection according to Bluetooth communication with the first electronic device 100, based on the MAC address of the standalone BT module 314 of the first electronic device 100.

According to an embodiment of the disclosure, the standalone BT module 414 of the second electronic device 200 may perform a Bluetooth connection operation of the standalone BT module 414, by transmitting a connection request to the first electronic device 100 by using the MAC address of the standalone BT module 314 of the first electronic device 100 and receiving, from the first electronic device 100, a connection acceptance notification in response to the connection request.

In operation 640, the second electronic device 200 may control the Wi-Fi/BT combo module 411 to establish a connection according to Wi-Fi communication with the first electronic device 100, based on the Wi-Fi connection information of the second electronic device 200.

According to an embodiment of the disclosure, the Wi-Fi/BT combo module 411 of the second electronic device 200 may receive, from the first electronic device 100, a connection request including Wi-Fi connection information required for the Wi-Fi connection of the second electronic device 200, and may perform a connection operation according to Wi-Fi communication with the first electronic device 100 by authenticating the first electronic device 100, based on the Wi-Fi connection information included in the received connection request.

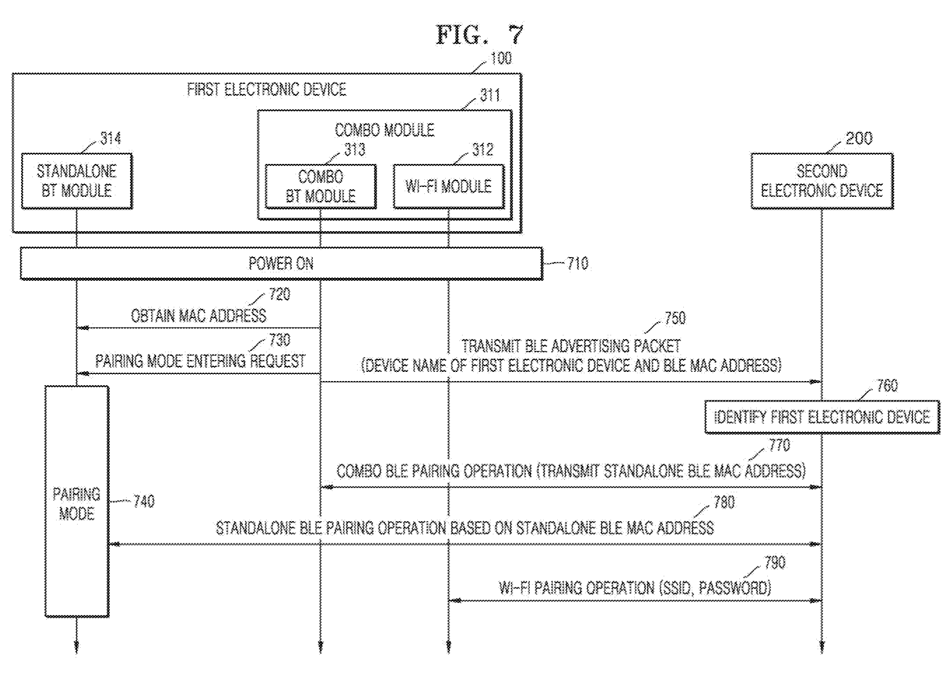

FIG. 7 is a flowchart of a wireless connection operation between a first electronic device and a second electronic device, according to an embodiment of the disclosure.

Referring to FIG. 7, in operation 710, the first electronic device 100 may be powered on.

According to an embodiment of the disclosure, the first electronic device 100 may be powered on during an OOBE stage. OOBE refers to an initial experience in which a user first unpacks and uses a purchased product, and in the OOBE stage, the first electronic device 100 may be powered on.

According to an embodiment of the disclosure, even in a state in which the first electronic device 100 is already in use by a user, when power of the first electronic device 100 is turned off and then turned on again for a reset, etc., the first electronic device 100 may be powered on. As such, when the first electronic device 100 is powered on, the operations illustrated in FIG. 7 may be performed to automatically connect the first electronic device 100 to the second electronic device 200.

In operation 720, the combo BT module 313 of the combo module 311 may obtain a MAC address of the standalone BT module 314, based on the powering on of the first electronic device 100. In BLE communication, the MAC address refers to a 48-bit address that uniquely identifies a BLE module on a network. The MAC address is a unique identifier assigned to a network interface, and each device within a BLE network may be distinguished by its unique MAC address. A BLE device may cause its MAC address to be included in an advertising packet to announce its presence to a peripheral device.

In operation 730, the combo BT module 313 of the combo module 311 may transmit a pairing mode entering request to the standalone BT module 314, based on the powering on of the first electronic device 100. The pairing mode entering request may represent a request for the standalone BT module 314 to switch to an initial preparation stage for setting a secure connection with another BLE device.

In operation 740, the standalone BT module 314 may enter a pairing mode in response to receiving the pairing mode entering request. In the pairing mode, the standalone BT module 314 may switch from a normal data communication or advertising mode to a ready state for initiating a pairing procedure for the secure connection.

In operation 750, the combo BT module 313 of the first electronic device 100 may transmit a BLE advertising packet to the second electronic device 200.

According to an embodiment of the disclosure, when the first electronic device 100 is powered on, the first electronic device 100 may broadcast an advertising packet to notify peripheral devices of its presence. A BLE advertising packet is a data packet that a BLE device periodically transmits to notify its surroundings of its presence and key information. The advertising packet serves as an initial signal for a connection request and allows the first electronic device 100 to broadcast its information while in a low-power state. In other words, the advertising packet may efficiently broadcast basic information of the first electronic device 100 that transmits the packet, thereby allowing the second electronic device 200 located in the vicinity to detect the first electronic device 100 and subsequently attempt connection.

According to an embodiment of the disclosure, the BLE advertising packet, which is transmitted to the second electronic device 200 by the combo BT module 313 of the combo module 311 of the first electronic device 100, may include a device name of the first electronic device 100 and a MAC address of the combo BT module 313. The device name of the first electronic device 100 represents a name that allows a user to easily recognize the device.

In operation 760, the second electronic device 200 may identify the first electronic device 100. The second electronic device 200 may identify the first electronic device 100, based on a device name of the first electronic device 100 included in the BLE advertising packet.

In operation 770, the first electronic device 100 and the second electronic device 200 may perform a combo BLE connection operation. The combo BLE connection operation may include a BLE communication connection operation between the combo BT module 313 and the combo BT module 413. The second electronic device 200 may identify the first electronic device 100 and then transmit a BLE connection request to the first electronic device 100, based on information obtained via the advertising packet. In this case, the first electronic device 100 and the second electronic device 200 may set an initial communication session for a BLE connection. After the connection is established, the first electronic device 100 and the second electronic device 200 may proceed a pairing procedure for a secure connection. The first electronic device 100 and the second electronic device 200 may exchange a temporary or secure key to share information necessary for encrypting subsequent communication, and based on the exchanged key, both devices may set an encrypted communication channel.

According to an embodiment of the disclosure, during the combo BLE connection operation between the first electronic device 100 and the second electronic device 200, the combo BT module 313 of the first electronic device 100 may transmit, to the second electronic device 200, the MAC address of the standalone BT module 314 obtained in operation 720, by using a BLE message. As such, during the BLE connection operation of the combo BT module 313, by transmitting the MAC address of the standalone BT module 314 to the second electronic device 200, time required for a connection operation of the standalone BT module 314 may be reduced.

In operation 780, the first electronic device 100 and the second electronic device 200 may perform a standalone BLE pairing operation, based on the MAC address of the standalone BT module 314.

According to an embodiment of the disclosure, the second electronic device 200 may transmit a standalone BLE connection request to the first electronic device 100 by using the MAC address of the standalone BT module 314 obtained during the combo BLE connection operation. In this case, the first electronic device 100 and the second electronic device 200 may set an initial communication session for a BLE connection. After the connection is established, the first electronic device 100 and the second electronic device 200 may proceed a pairing procedure for a secure connection. The first electronic device 100 and the second electronic device 200 may exchange a temporary or secure key to share information necessary for encrypting subsequent communication, and based on the exchanged key, both devices may set an encrypted communication channel.

In operation 790, the first electronic device 100 and the second electronic device 200 may perform a Wi-Fi pairing operation.

According to an embodiment of the disclosure, for Wi-Fi pairing between the first electronic device 100 and the second electronic device 200, the second electronic device 200 may serve as a Soft AP. In addition, to enable the first electronic device 100 to access the second electronic device 200 that serves as a Soft AP, the second electronic device 200 may transmit, to the first electronic device 100, Wi-Fi connection information for the access to the Soft AP of the second electronic device 200, via a BLE message. Then, the first electronic device 100 may transmit a connection request to the second electronic device 200 by using the Wi-Fi connection information received from the second electronic device 200, such that the first electronic device 100 and the second electronic device 200 may perform a Wi-Fi connection operation. The Wi-Fi connection information may include an SSID and a password.

In the example illustrated in FIG. 7, combo BLE pairing operation 770, standalone BLE operation 780, and Wi-Fi pairing operation 790 do not need to be performed in chronological order, and combo BLE pairing operation 770, standalone BLE operation 780, and Wi-Fi pairing operation 790 may be performed in parallel. In other words, one or more sub-operations for performing combo BLE pairing operation 770, one or more sub-operations for performing standalone BLE operation 780, and one or more sub-operations for performing Wi-Fi pairing operation 790 may be simultaneously processed in parallel. Accordingly, a wireless communication connection operation of the first electronic device 100 and the second electronic device 200 may be rapidly performed.

By allowing the operations illustrated in FIG. 7, which are automatically performed based on the powering on of the first electronic device 100, to proceed automatically with minimal user intervention, cumbersome manual input by a user may be minimized, thereby making user experience more convenient.

In operation 760 illustrated in FIG. 7, the identification of the first electronic device 100 by the second electronic device 200 may be performed in various ways. Hereinafter, a method, performed by the second electronic device 200, of identifying the first electronic device 100 with which a wireless communication connection is to be established will be described.

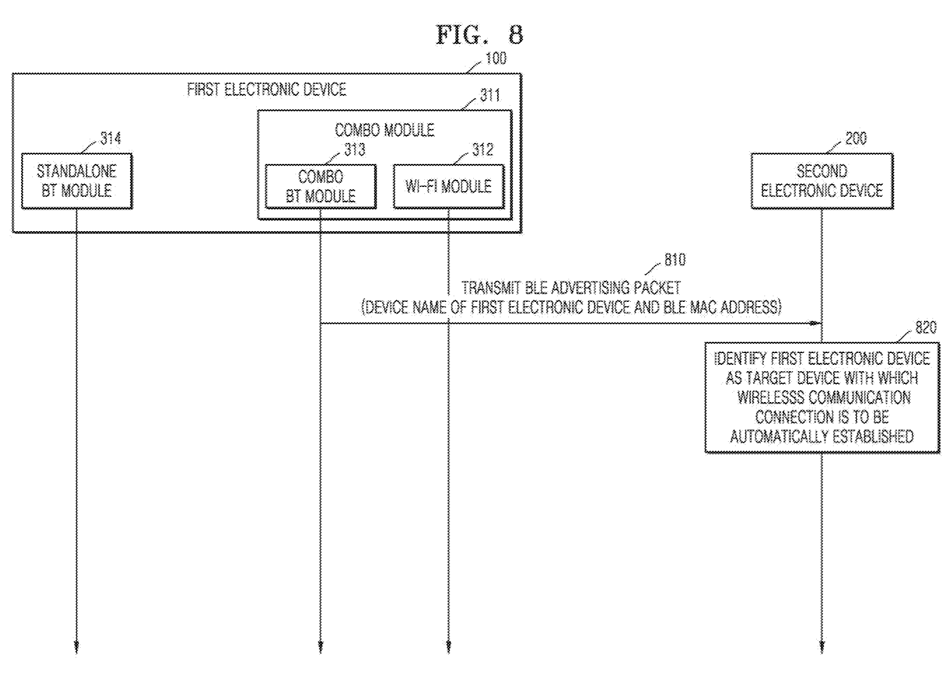

FIG. 8 is a flowchart of a method, performed by a second electronic device, of identifying a first electronic device with which a wireless communication connection is to be established, according to an embodiment of the disclosure.

Referring to FIG. 8, in operation 810, the combo BT module 313 of the first electronic device 100 may transmit a BLE advertising packet to the second electronic device 200. The BLE advertising packet, which is transmitted to the second electronic device 200 by the combo BT module 313 of the combo module 311 of the first electronic device 100, may include a device name of the first electronic device 100 and a MAC address of the combo BT module 313.

In operation 820, the second electronic device 200 may identify the first electronic device 100 as a target device with which a wireless communication connection is to be automatically established. The second electronic device 200 may identify the first electronic device 100, based on the device name of the first electronic device 100 included in the BLE advertising packet, and may determine the identified first electronic device 100 as a target device with which a wireless communication connection is to be automatically established.

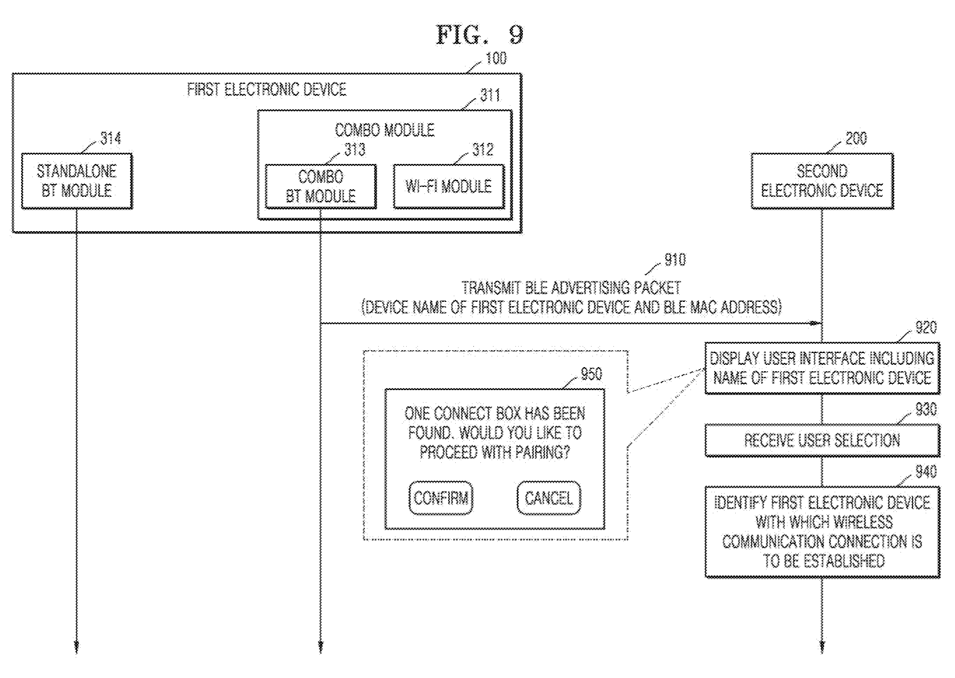

FIG. 9 is a flowchart of a method, performed by a second electronic device, of identifying a first electronic device with which a wireless communication connection is to be established, according to an embodiment of the disclosure.

Referring to FIG. 9, in operation 910, the combo BT module 313 of the first electronic device 100 may transmit a BLE advertising packet to the second electronic device 200. The BLE advertising packet, which is transmitted to the second electronic device 200 by the combo BT module 313 of the combo module 311 of the first electronic device 100, may include a device name of the first electronic device 100 and a MAC address of the combo BT module 313.

In operation 920, the second electronic device 200 may display a user interface including a name of the first electronic device 100. In other words, instead of determining the first electronic device 100, which is identified by the BLE advertising packet, as a target device with which a wireless communication connection is to be automatically established, the second electronic device 200 may display a user interface for identifying a user’s intention.

According to an embodiment of the disclosure, the second electronic device 200 may output a user interface for receiving a user input of selecting the first electronic device 100 as a device with which a wireless communication connection is to be automatically established. For example, the second electronic device 200 may display a user interface 950 as illustrated in FIG. 9. The user interface 950 may include a confirmation item 951 and a cancellation item 952 together with a message of <One Connect Box has been found. Would you like to proceed with pairing?>.

In operation 930, the second electronic device 200 may receive a user selection via the user interface. For example, the second electronic device 200 may receive a user input of selecting the confirmation item 951 or the cancellation item 952 in the user interface 950.

In operation 940, the second electronic device 200 may identify the first electronic device 100 as a target device with which a wireless communication connection is to be established, according to the user selection. For example, when receiving a user input of selecting the confirmation item 951, the second electronic device 200 may identify the first electronic device 100 as a target device with which a wireless communication connection is to be established. For example, when receiving a user input of selecting the cancellation item 952, the second electronic device 200 may terminate a wireless communication connection operation.

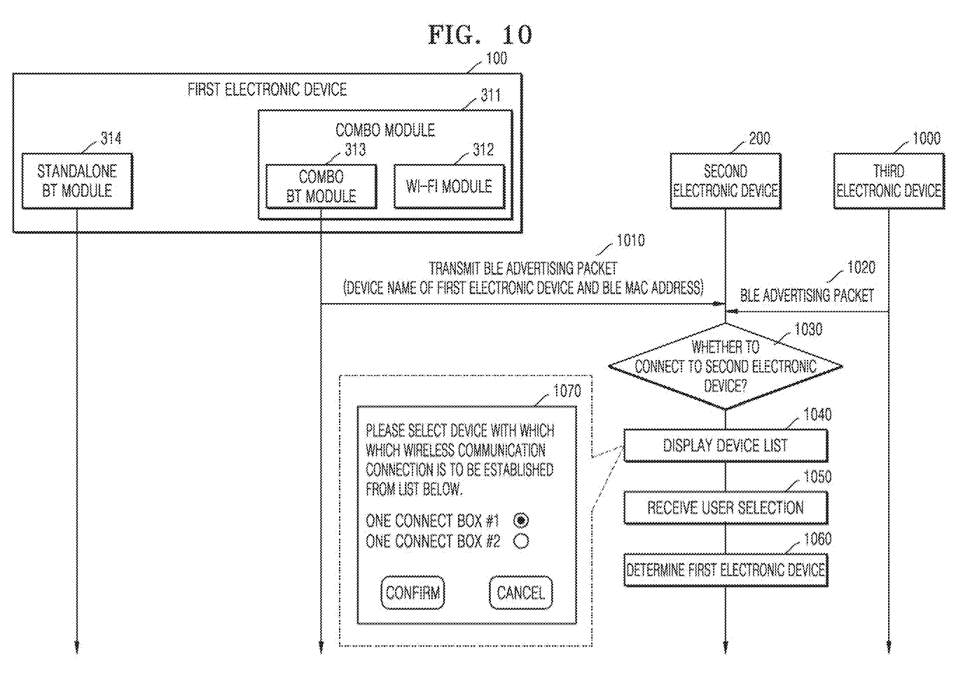

FIG. 10 is a flowchart of a method, performed by a second electronic device, of identifying a first electronic device with which a wireless communication connection is to be established, according to an embodiment of the disclosure.

Referring to FIG. 10, in operation 1010, the combo BT module 313 of the first electronic device 100 may transmit a BLE advertising packet to the second electronic device 200. The BLE advertising packet, which is transmitted to the second electronic device 200 by the combo BT module 313 of the combo module 311 of the first electronic device 100, may include a device name of the first electronic device 100 and a MAC address of the combo BT module 313. In addition, the BLE advertising packet may further include information about whether to connect to an electronic device. For example, the information about whether to connect to an electronic device may include information about whether to connect to the second electronic device 200. For example, when the first electronic device 100 performs a connection operation with the second electronic device 200 and thus is connected to the second electronic device 200, the information about whether to connect to an electronic device may include information such as <connected to the second electronic device>.

In operation 1020, the second electronic device 200 may also receive a BLE advertising packet from a third electronic device 1000. The BLE advertising packet, which is received from the third electronic device 1000 by the second electronic device 200, may include a device name of the third electronic device 1000, a MAC address of a BLE module, and information about whether to connect to an electronic device.

In operation 1030, the second electronic device 200 may obtain information about whether to connect to the second electronic device 200, by interpreting the information in the received BLE advertising packets. In addition, based on the information about whether to connect to the second electronic device 200, the second electronic device 200 may determine whether the devices that have transmitted the BLE advertising packets are in a connected state with the second electronic device 200, and may exclude an electronic device that is in the connected state and identify an electronic device that is not in the connected state.

In operation 1040, the second electronic device 200 may display a device list including electronic devices that are not connected to the second electronic device 200. In other words, the second electronic device 200 may display a device list including the device names of the first electronic device 100 and the third electronic device 1000 when both the first electronic device 100 and the third electronic device 1000 that have transmitted the BLE advertising packets are not in a connected state with the second electronic device 200. The second electronic device 200 may display a user interface including the device list to identify a user’s intention to select a target device with which a wireless communication connection is to be established.

According to an embodiment of the disclosure, the second electronic device 200 may output a user interface including a device list to receive a user input of selecting a device with which a wireless communication connection is to be established. For example, the second electronic device 200 may display a user interface 1070 as illustrated in FIG. 10. The user interface 1070 may include a confirmation item 1071 and a cancellation item 1072 together with a message of <Please select a device with which a wireless communication connection is to be established from the list below. One Connect Box #1, One Connect Box #2>. For example, One Connect Box #1 may be the device name of the first electronic device 100. For example, One Connect Box #2 may be the device name of the third electronic device 1000.

In operation 1050, the second electronic device 200 may receive a user selection via the user interface. For example, the second electronic device 200 may receive a user input of checking One Connect Box #1 in the user interface 1070 and selecting the confirmation item 1071. For example, the second electronic device 200 may receive a user input of checking One Connect Box #2 in the user interface 1070 and selecting the confirmation item 1071.

In operation 1060, the second electronic device 200 may identify the first electronic device 100 as a target device with which a wireless communication connection is to be established, according to the user selection. For example, when receiving a user input of checking One Connect Box #1 in the user interface 1070 and selecting the confirmation item 1071, the second electronic device 200 may identify the first electronic device 100 corresponding to One Connect Box #1 as a device with which a wireless communication connection is to be established. For example, when receiving a user input of checking One Connect Box #2 in the user interface 1070 and selecting the confirmation item 1071, the second electronic device 200 may identify the third electronic device 1000 corresponding to One Connect Box #2 as a device with which a wireless communication connection is to be established. For example, when receiving a user input of selecting the cancellation item 1072, the second electronic device 200 may terminate a wireless communication connection operation.

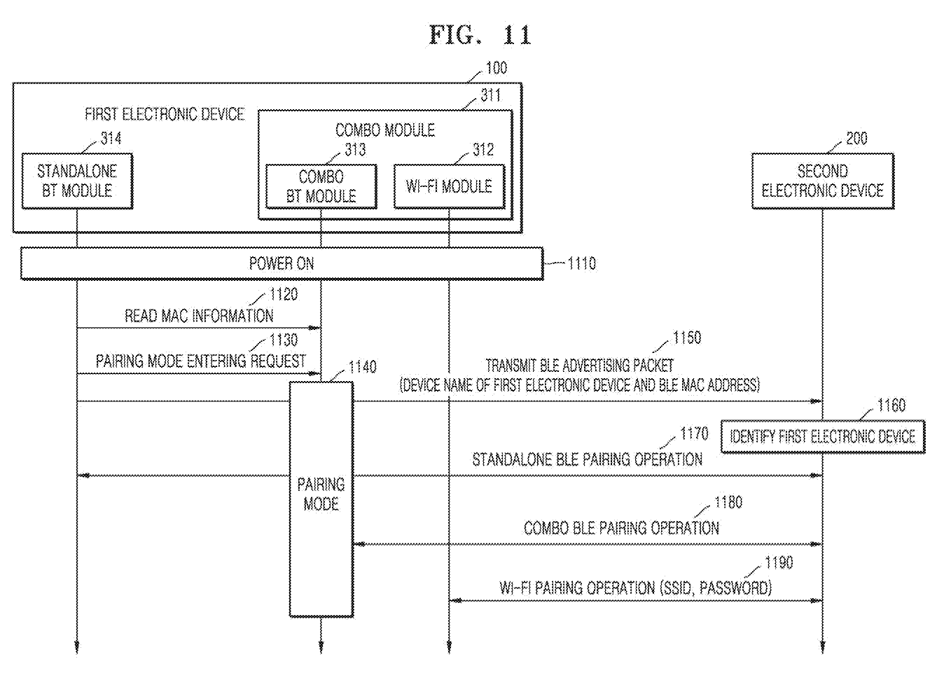

FIG. 11 is a flowchart of a wireless connection operation between a first electronic device and a second electronic device, according to an embodiment of the disclosure. In the wireless connection operation illustrated in FIG. 7, a BLE module of the combo module 311 triggers the wireless connection operation, but the disclosure is not necessarily limited thereto. In the example illustrated in FIG. 11, an example in which a standalone BLE module 314 triggers the wireless connection operation is described.

Referring to FIG. 11, in operation 1110, the first electronic device 100 may be powered on.

According to an embodiment of the disclosure, the first electronic device 100 may be powered on during an OOBE stage. OOBE refers to an initial experience in which a user first unpacks and uses a purchased product, and in the OOBE stage, the first electronic device 100 may be powered on.

According to an embodiment of the disclosure, even in a state in which the first electronic device 100 is already in use by a user, when power of the first electronic device 100 is turned off and then turned on again for a reset, etc., the first electronic device 100 may be powered on. As such, when the first electronic device 100 is powered on, the operations illustrated in FIG. 11 may be performed to automatically connect the first electronic device 100 to the second electronic device 200.

In operation 1120, the standalone BT module 314 may obtain a MAC address of the combo BT module 313 of the combo module 311, based on the powering on of the first electronic device 100. In BLE communication, the MAC address refers to a 48-bit address that uniquely identifies a BLE module on a network. The MAC address is a unique identifier assigned to a network interface, and each device within a BLE network may be distinguished by its unique MAC address. A BLE device may cause its MAC address to be included in an advertising packet to announce its presence to a peripheral device.

In operation 1130, the standalone BT module 314 may transmit a pairing mode entering request to the combo BT module 313 of the combo module 311, based on the powering on of the first electronic device 100. The pairing mode entering request may represent a request for the combo BT module 313 to switch to an initial preparation stage for setting a secure connection with another BLE device.

In operation 1140, the combo BT module 313 of the combo module 311 may enter a pairing mode in response to receiving the pairing mode entering request. In the pairing mode, the combo BT module 313 of the combo module 311 may switch from a normal data communication or advertising mode to a ready state for initiating a pairing procedure for the secure connection.

In operation 1150, the standalone BT module 314 of the first electronic device 100 may transmit a BLE advertising packet to the second electronic device 200.

According to an embodiment of the disclosure, when the first electronic device 100 is powered on, the first electronic device 100 may broadcast an advertising packet to notify peripheral devices of its presence. A BLE advertising packet is a data packet that a BLE device periodically transmits to notify its surroundings of its presence and key information. The advertising packet serves as an initial signal for a connection request and allows the first electronic device 100 to broadcast its information while in a low-power state. In other words, the advertising packet may efficiently broadcast basic information of the first electronic device 100 that transmits the packet, thereby allowing the second electronic device 200 located in the vicinity to detect the first electronic device 100 and subsequently attempt connection.

In operation 1160, the second electronic device 200 may identify the first electronic device 100. The second electronic device 200 may identify the first electronic device 100, based on a device name of the first electronic device 100 included in the BLE advertising packet.

In operation 1170, the first electronic device 100 and the second electronic device 200 may perform a standalone BLE connection operation. The second electronic device 200 may identify the first electronic device 100 and then transmit a connection request to the first electronic device 100, based on information obtained via the advertising packet. In this case, the first electronic device 100 and the second electronic device 200 may set an initial communication session for a BLE connection. After the connection is established, the first electronic device 100 and the second electronic device 200 may proceed a pairing procedure for a secure connection. The first electronic device 100 and the second electronic device 200 may exchange a temporary or secure key to share information necessary for encrypting subsequent communication, and based on the exchanged key, both devices may set an encrypted communication channel.

According to an embodiment of the disclosure, during the standalone BLE connection operation between the first electronic device 100 and the second electronic device 200, the standalone BT module 314 of the first electronic device 100 may transmit, to the second electronic device 200, the MAC address of the combo BT module 313 obtained in operation 1120, by using a BLE message. As such, during the standalone BLE connection operation, by transmitting the MAC address of the combo BT module 313 to the second electronic device 200, time required for a connection operation of a BLE module of the combo module 311 may be reduced.

In operation 1180, the first electronic device 100 and the second electronic device 200 may perform a combo BLE pairing operation, based on the MAC address of the combo BT module 313.

According to an embodiment of the disclosure, the second electronic device 200 may transmit a combo BLE connection request to the first electronic device 100 by using the MAC address of the combo BT module 313 obtained during the standalone BLE connection operation. In this case, the first electronic device 100 and the second electronic device 200 may set an initial communication session for a BLE connection. After the connection is established, the first electronic device 100 and the second electronic device 200 may proceed a pairing procedure for a secure connection. The first electronic device 100 and the second electronic device 200 may exchange a temporary or secure key to share information necessary for encrypting subsequent communication, and based on the exchanged key, both devices may set an encrypted communication channel.

In operation 1190, the first electronic device 100 and the second electronic device 200 may perform a Wi-Fi pairing operation.

According to an embodiment of the disclosure, for Wi-Fi pairing between the first electronic device 100 and the second electronic device 200, the second electronic device 200 may serve as a Soft AP. In addition, to enable the first electronic device 100 to access the second electronic device 200 that serves as a Soft AP, the second electronic device 200 may transmit, to the first electronic device 100, Wi-Fi connection information of the second electronic device 200 for the access to the Soft AP, via a BLE message. Then, the first electronic device 100 may transmit a connection request to the second electronic device 200 by using the Wi-Fi connection information received from the second electronic device 200, such that the first electronic device 100 and the second electronic device 200 may perform a Wi-Fi connection operation. The Wi-Fi connection information may include an SSID and a password.

In the example illustrated in FIG. 11, standalone BLE pairing operation 1170, combo BLE operation 1180, and Wi-Fi pairing operation 1190 do not need to be performed in chronological order, and standalone BLE pairing operation 1170, combo BLE operation 1180, and Wi-Fi pairing operation 1190 may be performed in parallel. In other words, one or more sub-operations for performing standalone BLE pairing operation 1170, one or more sub-operations for performing combo BLE operation 1180, and one or more sub-operations for performing Wi-Fi pairing operation 1190 may be simultaneously processed in parallel. Accordingly, a wireless communication connection operation of the first electronic device 100 and the second electronic device 200 may be rapidly performed.

By allowing the operations illustrated in FIG. 11, which are automatically performed based on the powering on of the first electronic device 100, to proceed automatically with minimal user intervention, cumbersome manual input by a user may be minimized, thereby making user experience more convenient.

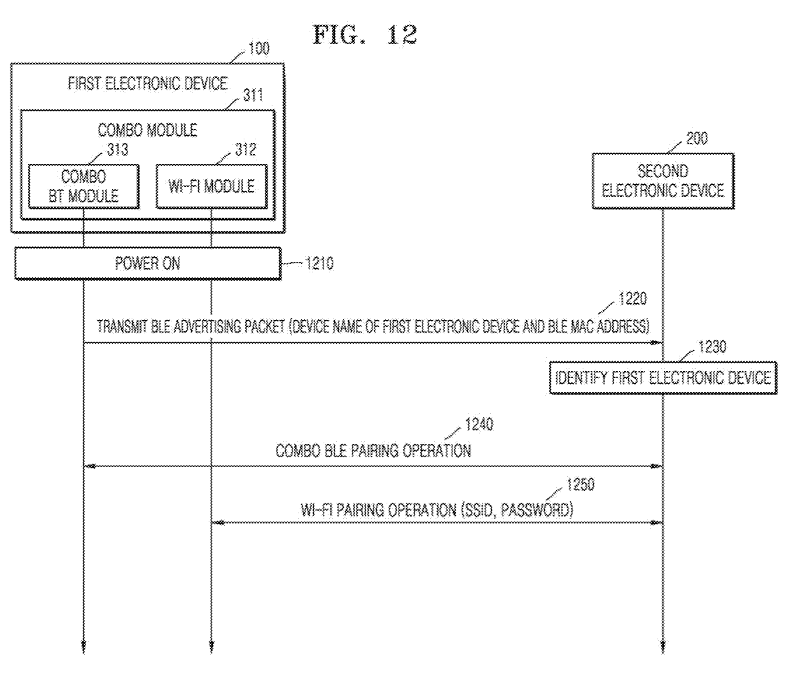

FIG. 12 is a flowchart of a wireless connection operation between a first electronic device and a second electronic device, according to an embodiment of the disclosure. In the example illustrated in FIGS. 7 or 11, the first electronic device 100 separately includes the standalone BT module to receive a power control-related control signal, in addition to the combo BT module, but in the example illustrated in FIG. 12, the first electronic device 100 does not include the standalone BT module, and the combo BT module may be responsible for receiving a power control-related control signal and control/state information.

Referring to FIG. 12, in operation 1210, the first electronic device 100 may be powered on.

According to an embodiment of the disclosure, the first electronic device 100 may be powered on during an OOBE stage. OOBE refers to an initial experience in which a user first unpacks and uses a purchased product, and in the OOBE stage, the first electronic device 100 may be powered on.

According to an embodiment of the disclosure, even in a state in which the first electronic device 100 is already in use by a user, when power of the first electronic device 100 is turned off and then turned on again for a reset, etc., the first electronic device 100 may be powered on. As such, when the first electronic device 100 is powered on, the operations illustrated in FIG. 12 may be performed to automatically connect the first electronic device 100 to the second electronic device 200.

In operation 1220, a BLE advertising packet may be transmitted to the second electronic device 200, based on the powering on of the first electronic device 100.

According to an embodiment of the disclosure, when the first electronic device 100 is powered on, the first electronic device 100 may broadcast an advertising packet to notify peripheral devices of its presence. A BLE advertising packet is a data packet that a BLE device periodically transmits to notify its surroundings of its presence and key information. The advertising packet serves as an initial signal for a connection request and allows the first electronic device 100 to broadcast its information while in a low-power state. In other words, the advertising packet may efficiently broadcast basic information of the first electronic device 100 that transmits the packet, thereby allowing the second electronic device 200 located in the vicinity to detect the first electronic device 100 and subsequently attempt connection.

According to an embodiment of the disclosure, the BLE advertising packet, which is transmitted to the second electronic device 200 by the combo BT module 313 of the combo module 311 of the first electronic device 100, may include a device name of the first electronic device 100 and a MAC address of the combo BT module 313. The device name of the first electronic device 100 represents a name that allows a user to easily recognize the device.

In operation 1230, the second electronic device 200 may identify the first electronic device 100. The second electronic device 200 may identify the first electronic device 100, based on a device name of the first electronic device 100 included in the BLE advertising packet.

In operation 1240, the first electronic device 100 and the second electronic device 200 may perform a combo BLE connection operation. The second electronic device 200 may identify the first electronic device 100 and then transmit a connection request to the first electronic device 100, based on information obtained via the advertising packet. In this case, the first electronic device 100 and the second electronic device 200 may set an initial communication session for a BLE connection. After the connection is established, the first electronic device 100 and the second electronic device 200 may proceed a pairing procedure for a secure connection. The first electronic device 100 and the second electronic device 200 may exchange a temporary or secure key to share information necessary for encrypting subsequent communication, and based on the exchanged key, both devices may set an encrypted communication channel.

In operation 1250, the first electronic device 100 and the second electronic device 200 may perform a Wi-Fi pairing operation.

According to an embodiment of the disclosure, for Wi-Fi pairing between the first electronic device 100 and the second electronic device 200, the second electronic device 200 may serve as a Soft AP. In addition, to enable the first electronic device 100 to access the second electronic device 200 that serves as a Soft AP, the second electronic device 200 may transmit, to the first electronic device 100, Wi-Fi connection information for the access to the Soft AP of the second electronic device 200, via a BLE message. Then, the first electronic device 100 may transmit a connection request to the second electronic device 200 by using the Wi-Fi connection information received from the second electronic device 200, such that the first electronic device 100 and the second electronic device 200 may perform a Wi-Fi connection operation. The Wi-Fi connection information may include an SSID and a password.

In the example illustrated in FIG. 12, combo BLE pairing operation 1240 and Wi-Fi pairing operation 1250 do not need to be performed in chronological order, and combo BLE pairing operation 1240 and Wi-Fi pairing operation 1250 may be performed in parallel. In other words, one or more sub-operations for performing combo BLE pairing operation 1240 and one or more sub-operations for performing Wi-Fi pairing operation 1250 may be simultaneously processed in parallel. Accordingly, a wireless communication connection operation of the first electronic device 100 and the second electronic device 200 may be rapidly performed.

By allowing the operations illustrated in FIG. 12, which are automatically performed based on the powering on of the first electronic device 100, to proceed automatically with minimal user intervention, cumbersome manual input by a user may be minimized, thereby making user experience more convenient.

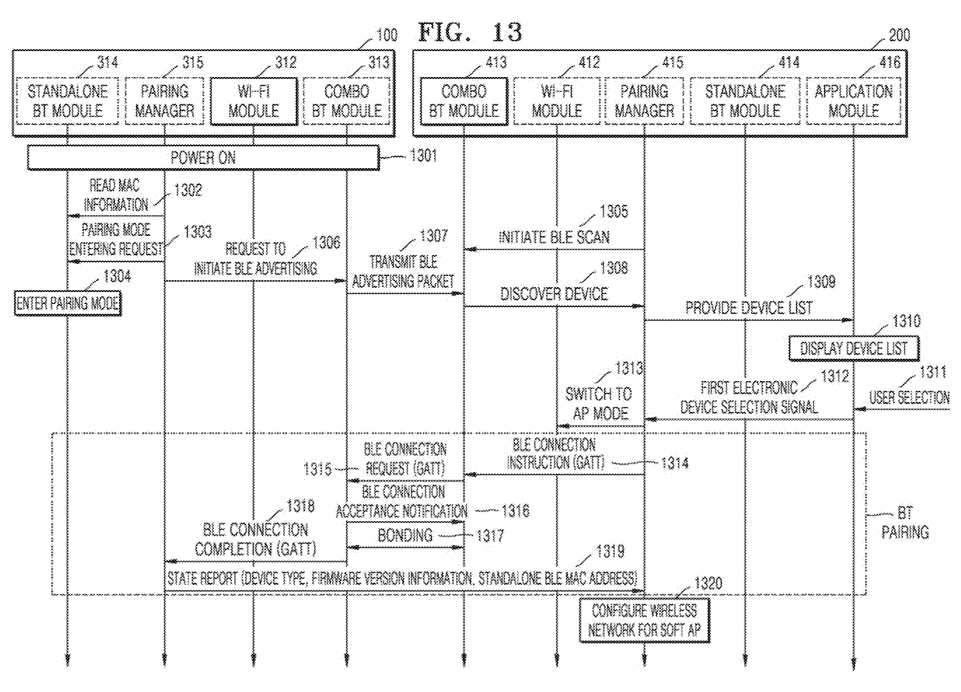

FIG. 13 is a flowchart illustrating an example of detailed operations in a process of wireless communication connection between a first electronic device and a second electronic device, according to an embodiment of the disclosure. In FIG. 13, a pairing manager 315 of the first electronic device 100 may include a program module that controls the Wi-Fi module 312, the combo BT module 313, and the standalone BT module 314. In FIG. 13, a pairing manager 415 of the second electronic device 200 may include a program module that controls the Wi-Fi module 412, the combo BT module 413, and the standalone BT module 414.

Referring to FIG. 13, the first electronic device 100 may be powered on.

According to an embodiment of the disclosure, the first electronic device 100 may be powered on during an OOBE stage. OOBE refers to an initial experience in which a user first unpacks and uses a purchased product, and in the OOBE stage, the first electronic device 100 may be powered on.

According to an embodiment of the disclosure, even in a state in which the first electronic device 100 is already in use by a user, when power of the first electronic device 100 is turned off and then turned on again for a reset, etc., the first electronic device 100 may be powered on. As such, when the first electronic device 100 is powered on, the operations illustrated in FIG. 13 may be performed to automatically connect the first electronic device 100 to the second electronic device 200.

In operation 1302, the pairing manager 315 may obtain a MAC address of the standalone BT module 314, based on the powering on of the first electronic device 100. In BLE communication, the MAC address refers to a 48-bit address that uniquely identifies a BLE module on a network. The MAC address is a unique identifier assigned to a network interface, and each device within a BLE network may be distinguished by its unique MAC address. A BLE device may cause its MAC address to be included in an advertising packet to announce its presence to a peripheral device.

In operation 1303, the pairing manager 315 may transmit a pairing mode entering request to the standalone BT module 314, based on the powering on of the first electronic device 100. The pairing mode entering request may represent a request for the standalone BT module 314 to switch to an initial preparation stage for setting a secure connection with another BLE device.

In operation 1304, the standalone BT module 314 may enter a pairing mode in response to receiving the pairing mode entering request. In the pairing mode, the standalone BT module 314 may switch from a normal data communication or advertising mode to a ready state for initiating a pairing procedure for the secure connection.

In operation 1305, the pairing manager 415 of the second electronic device 200 may instruct the combo BT module 413 to initiate a BLE scan. For example, when a user intends to connect the first electronic device 100 to the second electronic device 200, the user may control initiation of a BLE scan by using a menu provided by the second electronic device 200. For example, the second electronic device 200 may provide a settings menu for initiating a BLE scan, and the second electronic device 200 may initiate the BLE scan in response to receiving, from the settings menu, an input for initiating the BLE scan. In response to the instruction from the pairing manager 415 to initiate the BLE scan, the combo BT module 413 may perform a BLE scan operation. The BLE scan operation may include periodically monitoring advertising channels in order for a central device to receive advertising packets transmitted by peripheral devices. Via the BLE scan, the combo BT module 413 may select a device with which a wireless connection is to be established, based on information in received advertising packets.

In operation 1306, the pairing manager 315 of the first electronic device 100 may request the combo BT module 313 to initiate BLE advertising.

In operation 1307, the combo BT module 313 may transmit a BLE advertising packet to the second electronic device 200. According to an embodiment of the disclosure, the BLE advertising packet, which is transmitted to the second electronic device 200 by the combo BT module 313 of the first electronic device 100, may include a device name of the first electronic device 100 and a MAC address of the combo BT module 313. The device name of the first electronic device 100 represents a name that allows a user to easily recognize the device.

In operation 1308, the combo BT module 413 may discover the first electronic device 100 via the BLE scan operation and may notify the pairing manager 415 of the discovered first electronic device 100. The combo BT module 413 of the second electronic device 200 may receive the BLE advertising packet transmitted by the combo BT module 313 of the first electronic device 100 via the BLE scan operation. The combo BT module 413 may detect the first electronic device 100, based on a device name of the first electronic device 100 included in the received BLE advertising packet. Then, the combo BT module 413 may transmit information about the first electronic device 100 to the pairing manager 415.

In operation 1309, the pairing manager 415 may transmit the information about the first electronic device 100 to an application module 416. When receiving one or more BLE advertising packets, the combo BT module 413 may transmit a device list including information about one or more electronic devices to the application module 416.

In operation 1310, the application module 416 may display a device list on a display. This is intended to provide, when there are a plurality of devices to be wirelessly connected to the second electronic device 200, a user with a list of these devices attempting the wireless connection, so as to allow the user to select one device from the list. The BLE advertising packet may include connection-status information with respect to the second electronic device, indicating whether a connection has been made. For example, when the connection-status information indicates that device A has not previously been connected to the second electronic device, device A may be included in a device list. When the connection-status information indicates that device A has previously been connected to the second electronic device, device A may be excluded from the device list.

In operation 1311, the application module 416 may receive a user input of selecting one electronic device via a user interface including the device list. Hereinafter, for convenience of explanation, it is assumed that a user input of selecting the first electronic device 100 has been received.

In operation 1312, the application module 416 may transmit, to the pairing manager 415, a signal indicating that the first electronic device 100 has been selected.

In operation 1313, the pairing manager 415 may transmit an instruction to switch the Wi-Fi module 412 from a general client mode to an AP mode. When a Wi-Fi chip of a terminal switches from a general client mode to an AP mode, the Wi-Fi chip may stop its existing client (station, STA) role and may start operating as an AP to enable other devices to connect to the AP. A Soft AP refers to a function that enables a terminal to create and manage a Wi-Fi network without a dedicated AP hardware. The Soft AP enables other devices to connect to the network created by the Soft AP and access the Internet or a local resource. The Soft AP, which is a software-based AP, may function as an AP by controlling a device’s wireless network interface in a software manner. The Soft AP may configure a wireless network by setting its own SSID, security settings (for example, WPA2 or WPA3), etc., and may enable peripheral devices to access the network. In response to such a Soft AP start instruction, the Wi-Fi module 412 switches a Wi-Fi mode to an AP mode. In this process, the terminal may set its own IP address, subnet, dynamic host configuration protocol (DHCP) server, etc. to provide network information to a client device. A device set as a Soft AP may receive a connection request and may establish a connection with a client via authentication and security procedures. The SSID is the name of the created network and is displayed so that a user may search for and access the network.

In operation 1314, the pairing manager 415 may transmit a BLE connection instruction to the combo BT module 413. For example, the pairing manager 415 may transmit a generic attribute profile (GATT)-based BLE connection instruction to the combo BT module 413. In BLE, a “GATT connection” refers to a connection established between two BLE devices for exchanging data based on a GATT protocol, wherein, typically, one device functions as a GATT server (for example, a sensor or a peripheral device), while the other device may function as a GATT client (for example, a smartphone or a central device). When a central device (the second electronic device 200 in the example of FIG. 13) discovers a peripheral device via advertising and scanning processes, and then transmits a connection request such that a physical BLE connection is established, GATT messages may be transmitted and received over this connection. The GATT server provides data in the form of services and characteristics, and the GATT client may perform a necessary operation such as reading or writing the data.

In operation 1315, the combo BT module 413 of the second electronic device 200 may transmit a BLE connection request to the combo BT module 313 of the first electronic device 100.

In operation 1316, the combo BT module 313 of the first electronic device 100 may transmit a BLE connection acceptance notification to the combo BT module 413 of the second electronic device 200. Via the BLE connection request and the BLE connection acceptance notification, the first electronic device 100 and the second electronic device 200 may establish a connection and may form a communication channel through which they may exchange data.

In operation 1317, the combo BT module 313 of the first electronic device 100 and the combo BT module 413 of the second electronic device 200 may perform a BLE bonding operation. Bonding refers to a process, after devices are connected, of exchanging encryption keys and security information between the devices to enhance security, wherein the exchanged security information is stored in respective device, allowing an encrypted communication channel to be rapidly restored in subsequent connections without additional authentication.

In operation 1318, the combo BT module 313 of the first electronic device 100 may transmit a BLE connection completion message to the pairing manager 315.

In operation 1319, the pairing manager 315 may transmit a state report to the pairing manager 415 of the second electronic device 200. The state report may include a device type of the first electronic device 100, currently-running firmware version information, etc. The state report may be transmitted via a specific service and characteristic within a BLE GATT profile.

According to an embodiment of the disclosure, the state report may include the MAC address of the standalone BT module 314. By causing the MAC address of the standalone BT module 314 to be included in the state report transmitted based on a combo BLE connection, a standalone BLE connection operation may be rapidly performed.

As such, according to operation 1314 to operation 1319 described above, a BLE connection operation may be performed between the combo BT module 313 of the first electronic device 100 and the combo BT module 413 of the second electronic device 200.

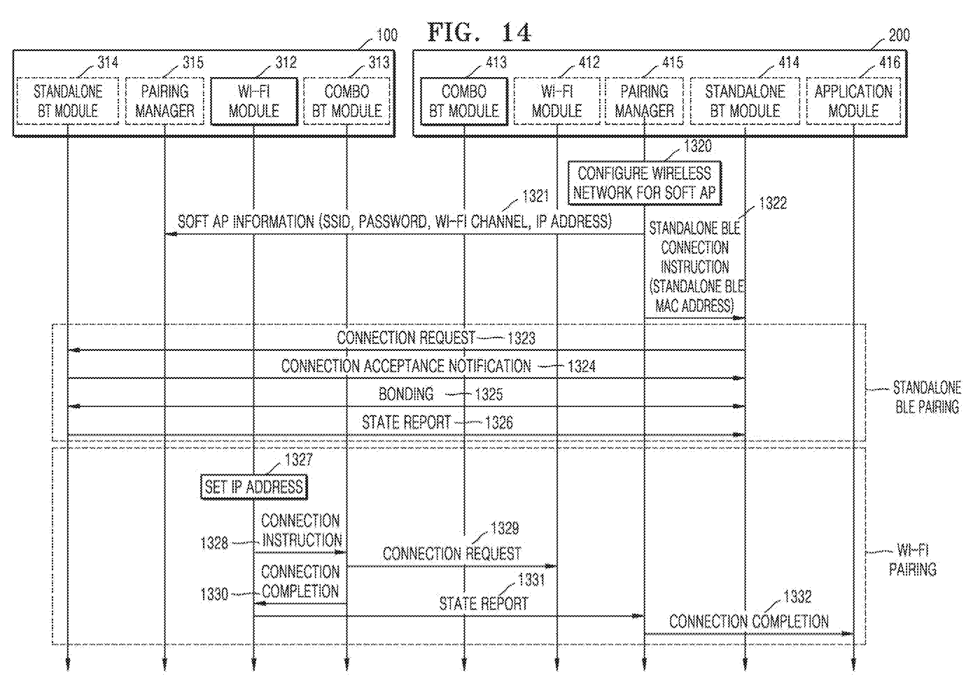

FIG. 14 is a flowchart illustrating an example of detailed operations in a process of wireless communication connection between a first electronic device and a second electronic device, according to an embodiment of the disclosure. The operations illustrated in FIG. 14 may be performed following the operations illustrated in FIG. 13.

Referring to FIG. 14, in operation 1320, the pairing manager 415 of the second electronic device 200 may configure a wireless network for a Soft AP. For the wireless network configuration, the pairing manager 415 may perform SSID setting, security and encryption, channel selection, and IP address and DHCP server assignment. The SSID setting refers to specifying the name (SSID) of a network to be created such that a client may identify the network when searching for the network. The security and encryption refers to selecting a security protocol such as WPA2 or WPA3 and setting an access password to prevent unauthorized access. The channel selection refers to selecting a Wi-Fi channel in consideration of a usage environment (interference, signal strength, etc.) The IP address and DHCP server assignment refers to a terminal itself performing the role of a DHCP server to automatically assign network information such as an IP address, a subnet mask, a gateway, and a DNS server to a connected client.

In operation 1321, the pairing manager 415 may transmit information about the Soft AP to the pairing manager 315 of the first electronic device 100. The information about the Soft AP may include, for example, an SSID, a password, IP addresses of the first electronic device 100 and the second electronic device 200, and a Wi-Fi channel. The pairing manager 415 may use a fixed IP address instead of DHCP to rapidly obtain the IP addresses of the first electronic device 100 and the second electronic device 200. The pairing manager 415 may transmit the information about the Soft AP to the pairing manager 315 of the first electronic device 100 by using a BLE GATT message.

In operation 1322, the pairing manager 415 may transmit a standalone BLE connection instruction to the standalone BT module 414. In this case, the pairing manager 415 may provide the MAC address of the standalone BT module 314 of the first electronic device 100, which is obtained via the state report in operation 1319, to the standalone BT module 414.

In operation 1323, the standalone BT module 414 of the second electronic device 200 may transmit a BLE connection request to the standalone BT module 314 of the first electronic device 100.

In operation 1324, the standalone BT module 314 of the first electronic device 100 may transmit a BLE connection acceptance notification to the standalone BT module 414 of the second electronic device 200. Via the BLE connection request and the BLE connection acceptance notification, the first electronic device 100 and the second electronic device 200 may establish a connection and may form a communication channel through which they may exchange data.

In operation 1325, the standalone BT module 314 of the first electronic device 100 and the standalone BT module 414 of the second electronic device 200 may perform a BLE bonding operation. Bonding refers to a process, after devices are connected, of exchanging encryption keys and security information between the devices to enhance security, wherein the exchanged security information is stored in respective device, allowing an encrypted communication channel to be rapidly restored in subsequent connections without additional authentication.

In operation 1326, the pairing manager 315 may transmit a state report to the pairing manager 415 of the second electronic device 200. The state report may include a device type of the first electronic device 100, currently-running firmware version information, etc. The state report may be transmitted via a specific service and characteristic within a BLE GATT profile.

As such, according to operation 1323 to operation 1326, a standalone BLE pairing operation between the first electronic device 100 and the second electronic device 200 may be performed.

In operation 1327, the pairing manager 315 may set an IP address.

In operation 1328, the pairing manager 315 may transmit a Wi-Fi connection instruction to the Wi-Fi module 312.

In operation 1329, the Wi-Fi module 312 may transmit a connection request to the Wi-Fi module 412 of the second electronic device 200. The Wi-Fi module 312 may transmit the connection request to the Wi-Fi module 412, by using the Soft AP information received from the second electronic device 200 in operation 1321. For example, the Wi-Fi module 312 may transmit the connection request to the Wi-Fi module 412 by using the SSID and the password among the Soft AP information received from the second electronic device 200. In addition, in response to the connection request, the Wi-Fi module 412 of the second electronic device 200 may authenticate the first electronic device 100, based on the received password. When the authentication is completed, the first electronic device 100 and the second electronic device 200 may complete the connection setup.

In operation 1330, the Wi-Fi module 312 may notify the pairing manager 315 of the connection completion.

In operation 1331, the pairing manager 315 may transmit a state report to the pairing manager 415 of the second electronic device 200.

In operation 1332, the pairing manager 415 may notify the application module 416 of Wi-Fi connection completion.

As such, according to operation 1320, 1321, and 1327 to 1332, a Wi-Fi pairing operation between the first electronic device 100 and the second electronic device 200 may be performed.

Hereinbefore, as described above with reference to FIGS. 13 and 14, the operations for combo BLE pairing, the operations for standalone BLE pairing, and the operations for Wi-Fi pairing have been illustrated and described sequentially for convenience of explanation. However, the operations for combo BLE pairing, the operations for standalone BLE pairing, and the operations for Wi-Fi pairing may be performed in a different order and may be performed in parallel between the first electronic device 100 and the second electronic device 200.

According to an embodiment of the disclosure, a first electronic device may include a communication interface including a standalone BT module and a Wi-Fi/BT combo module, memory storing one or more instructions, and at least one processor configured to execute the one or more instructions stored in the memory.

According to an embodiment of the disclosure, the one or more instructions, when executed by the at least one processor individually and/or collectively, may cause the first electronic device to control the Wi-Fi/BT combo module to obtain a MAC address of the standalone BT module, based on powering on of the first electronic device.

According to an embodiment of the disclosure, the one or more instructions, when executed by the at least one processor individually and/or collectively, may cause the first electronic device to control the Wi-Fi/BT combo module to establish a connection according to Bluetooth communication with a second electronic device.

According to an embodiment of the disclosure, the one or more instructions, when executed by the at least one processor individually and/or collectively, may cause the first electronic device to control the Wi-Fi/BT combo module to transmit the MAC address of the standalone BT module to the second electronic device via the Bluetooth communication connection between the Wi-Fi/BT combo module and the second electronic device and receive Wi-Fi connection information of the second electronic device.

According to an embodiment of the disclosure, the one or more instructions, when executed by the at least one processor individually and/or collectively, may cause the first electronic device to control the standalone BT module to establish a connection according to Bluetooth communication with the second electronic device, based on the MAC address of the standalone BT module transmitted to the second electronic device.

According to an embodiment of the disclosure, the one or more instructions, when executed by the at least one processor individually and/or collectively, may cause the first electronic device to control the Wi-Fi/BT combo module to establish a connection according to Wi-Fi communication with the second electronic device, based on the Wi-Fi connection information of the second electronic device received from the second electronic device.

According to an embodiment of the disclosure, the one or more instructions, when executed by the at least one processor individually and/or collectively, may cause the first electronic device to control the Wi-Fi/BT combo module to transmit a request to the standalone BT module to enter a pairing mode, based on the powering on of the first electronic device.

According to an embodiment of the disclosure, the one or more instructions, when executed by the at least one processor individually and/or collectively, may cause the first electronic device to control the Wi-Fi/BT combo module to transmit, to the second electronic device, a Bluetooth message including the MAC address of the standalone BT module.

According to an embodiment of the disclosure, the one or more instructions, when executed by the at least one processor individually and/or collectively, may cause the first electronic device to receive, from the second electronic device, a connection request based on the Bluetooth communication with the standalone BT module, using the MAC address of the standalone BT module.

According to an embodiment of the disclosure, the one or more instructions, when executed by the at least one processor individually and/or collectively, may cause the first electronic device to control the standalone BT module to perform a connection operation based on the Bluetooth communication with the second electronic device, in response to receiving the connection request.

According to an embodiment of the disclosure, the one or more instructions, when executed by the at least one processor individually and/or collectively, may cause the first electronic device to control receiving of, from the second electronic device, a Bluetooth message including the Wi-Fi connection information of the second electronic device.

According to an embodiment of the disclosure, the one or more instructions, when executed by the at least one processor individually and/or collectively, may cause the first electronic device to control the Wi-Fi/BT combo module to transmit, to the second electronic device, a connection request based on the Wi-Fi communication with the second electronic device, by using the Wi-Fi connection information of the second electronic device.

According to an embodiment of the disclosure, the one or more instructions, when executed by the at least one processor individually and/or collectively, may cause the first electronic device to control the Wi-Fi/BT combo module to perform a connection operation based on the Wi-Fi communication with the second electronic device, based on the connection request.

According to an embodiment of the disclosure, the Wi-Fi connection information may include an SSID and a password of a Soft AP of the second electronic device.

According to an embodiment of the disclosure, the one or more instructions, when executed by the at least one processor individually and/or collectively, may cause the first electronic device to control the standalone BT module to receive, from the second electronic device, a control signal related to power control of the first electronic device, according to the Bluetooth communication connection between the standalone BT module and the second electronic device.

According to an embodiment of the disclosure, the one or more instructions, when executed by the at least one processor individually and/or collectively, may cause the first electronic device to control the Wi-Fi/BT combo module to transmit audio-visual data to the second electronic device, according to the Wi-Fi communication connection between the Wi-Fi/BT combo module and the second electronic device.

According to an embodiment of the disclosure, the one or more instructions, when executed by the at least one processor individually and/or collectively, may cause the first electronic device to control the Wi-Fi/BT combo module to receive Wi-Fi communication-related state and/or control information from the second electronic device, according to the Bluetooth communication connection between the Wi-Fi/BT combo module and the second electronic device.

According to an embodiment of the disclosure, a second electronic device may include a communication interface including a standalone BT module and a Wi-Fi/BT combo module, memory storing one or more instructions, and at least one processor configured to execute the one or more instructions stored in the memory.

According to an embodiment of the disclosure, the one or more instructions, when executed by the at least one processor individually and/or collectively, may cause the second electronic device to control the Wi-Fi/BT combo module to establish a connection according to Bluetooth communication, in response to receiving a Bluetooth advertising packet from a first electronic device.

According to an embodiment of the disclosure, the one or more instructions, when executed by the at least one processor individually and/or collectively, may cause the second electronic device to control the Wi-Fi/BT combo module to receive a MAC address of the standalone BT module of the first electronic device from the first electronic device via the Bluetooth communication connection between the Wi-Fi/BT combo module and the first electronic device and transmit Wi-Fi connection information of the second electronic device to the first electronic device.

According to an embodiment of the disclosure, the one or more instructions, when executed by the at least one processor individually and/or collectively, may cause the second electronic device to control the standalone BT module to establish a connection according to Bluetooth communication with the first electronic device, based on the MAC address of the standalone BT module of the first electronic device.

According to an embodiment of the disclosure, the one or more instructions, when executed by the at least one processor individually and/or collectively, may cause the second electronic device to control the Wi-Fi/BT combo module to establish a connection according to Wi-Fi communication with the first electronic device, based on the Wi-Fi connection information of the second electronic device.

According to an embodiment of the disclosure, the one or more instructions, when executed by the at least one processor individually and/or collectively, may cause the second electronic device to control the Wi-Fi/BT combo module to receive a Bluetooth message including the MAC address of the standalone BT module of the first electronic device.

According to an embodiment of the disclosure, the one or more instructions, when executed by the at least one processor individually and/or collectively, may cause the second electronic device to control the standalone BT module to transmit, to the first electronic device, a connection request based on the Bluetooth communication with the first electronic device, using the MAC address of the standalone BT module of the first electronic device.

According to an embodiment of the disclosure, the one or more instructions, when executed by the at least one processor individually and/or collectively, may cause the second electronic device to control the standalone BT module to perform a connection operation based on the Bluetooth communication with the first electronic device, in response to transmitting the connection request.

According to an embodiment of the disclosure, the one or more instructions, when executed by the at least one processor individually and/or collectively, may cause the second electronic device to control the Wi-Fi/BT combo module to transmit, to the first electronic device, a Bluetooth message including the Wi-Fi connection information of the second electronic device, the Wi-Fi connection information corresponding to a wireless network generated for a Soft AP.

According to an embodiment of the disclosure, the one or more instructions, when executed by the at least one processor individually and/or collectively, may cause the second electronic device to control the Wi-Fi/BT combo module to receive, from the first electronic device, a connection request based on the Wi-Fi connection information of the second electronic device.

According to an embodiment of the disclosure, the one or more instructions, when executed by the at least one processor individually and/or collectively, may cause the second electronic device to control the Wi-Fi/BT combo module to perform a connection operation based on the Wi-Fi communication with the first electronic device, based on the connection request.

According to an embodiment of the disclosure, a method of operating a first electronic device including a standalone BT module and a Wi-Fi/BT combo module may include controlling the Wi-Fi/BT combo module to obtain a MAC address of the standalone BT module, based on powering on of the first electronic device.

According to an embodiment of the disclosure, the method of operating the first electronic device including the standalone BT module and the Wi-Fi/BT combo module may include controlling the Wi-Fi/BT combo module to establish a connection according to Bluetooth communication with a second electronic device.

According to an embodiment of the disclosure, the method of operating the first electronic device including the standalone BT module and the Wi-Fi/BT combo module may include controlling the Wi-Fi/BT combo module to transmit the MAC address of the standalone BT module to the second electronic device via the Bluetooth communication connection between the Wi-Fi/BT combo module and the second electronic device and receive Wi-Fi connection information of the second electronic device.

According to an embodiment of the disclosure, the method of operating the first electronic device including the standalone BT module and the Wi-Fi/BT combo module may include controlling the standalone BT module to establish a connection according to Bluetooth communication with the second electronic device, based on the MAC address of the standalone BT module transmitted to the second electronic device.

According to an embodiment of the disclosure, the method of operating the first electronic device including the standalone BT module and the Wi-Fi/BT combo module may include controlling the Wi-Fi/BT combo module to establish a connection according to Wi-Fi communication with the second electronic device, based on the Wi-Fi connection information of the second electronic device received from the second electronic device.

According to an embodiment of the disclosure, the method of operating the first electronic device including the standalone BT module and the Wi-Fi/BT combo module may further include controlling the Wi-Fi/BT combo module to transmit a request to the standalone BT module to enter a pairing mode, based on the powering on of the first electronic device.

According to an embodiment of the disclosure, the method of operating the first electronic device including the standalone BT module and the Wi-Fi/BT combo module may further include controlling the Wi-Fi/BT combo module to transmit, to the second electronic device, a Bluetooth message including the MAC address of the standalone BT module.

According to an embodiment of the disclosure, the method of operating the first electronic device including the standalone BT module and the Wi-Fi/BT combo module may further include receiving, from the second electronic device, a connection request based on the Bluetooth communication with the standalone BT module, using the MAC address of the standalone BT module.

According to an embodiment of the disclosure, the method of operating the first electronic device including the standalone BT module and the Wi-Fi/BT combo module may further include controlling the standalone BT module to perform a connection operation based on the Bluetooth communication with the second electronic device, in response to receiving the connection request.

According to an embodiment of the disclosure, the method of operating the first electronic device including the standalone BT module and the Wi-Fi/BT combo module may further include controlling to receive, from the second electronic device, a Bluetooth message including the Wi-Fi connection information of the second electronic device.

According to an embodiment of the disclosure, the method of operating the first electronic device including the standalone BT module and the Wi-Fi/BT combo module may further include controlling the Wi-Fi/BT combo module to transmit, to the second electronic device, a connection request based on the Wi-Fi communication with the second electronic device, by using the Wi-Fi connection information of the second electronic device.

According to an embodiment of the disclosure, the method of operating the first electronic device including the standalone BT module and the Wi-Fi/BT combo module may further include controlling the Wi-Fi/BT combo module to perform a connection operation based on the Wi-Fi communication with the second electronic device, based on the connection request.

According to an embodiment of the disclosure, the Wi-Fi connection information may include an SSID and a password of a Soft AP of the second electronic device.

According to an embodiment of the disclosure, the method of operating the first electronic device including the standalone BT module and the Wi-Fi/BT combo module may further include controlling the standalone BT module to receive, from the second electronic device, a control signal related to power control of the first electronic device, according to the Bluetooth communication connection between the standalone BT module and the second electronic device.

According to an embodiment of the disclosure, the method of operating the first electronic device including the standalone BT module and the Wi-Fi/BT combo module may further include controlling the Wi-Fi/BT combo module to transmit audio-visual data to the second electronic device, according to the Wi-Fi communication connection between the Wi-Fi/BT combo module and the second electronic device.

According to an embodiment of the disclosure, the method of operating the first electronic device including the standalone BT module and the Wi-Fi/BT combo module may further include controlling the Wi-Fi/BT combo module to receive Wi-Fi communication-related state and/or control information from the second electronic device, according to the Bluetooth communication connection between the Wi-Fi/BT combo module and the second electronic device.

According to an embodiment of the disclosure, a method of operating a second electronic device including a standalone BT module and a Wi-Fi/BT combo module may include controlling the Wi-Fi/BT combo module to establish a connection according to Bluetooth communication, in response to receiving a Bluetooth advertising packet from a first electronic device.

According to an embodiment of the disclosure, the method of operating the second electronic device including the standalone BT module and the Wi-Fi/BT combo module may include controlling the Wi-Fi/BT combo module to receive a MAC address of the standalone BT module of the first electronic device from the first electronic device via the Bluetooth communication connection between the Wi-Fi/BT combo module and the first electronic device.

According to an embodiment of the disclosure, the method of operating the second electronic device including the standalone BT module and the Wi-Fi/BT combo module may include controlling the Wi-Fi/BT combo module to transmit Wi-Fi connection information of the second electronic device to the first electronic device.

According to an embodiment of the disclosure, the method of operating the second electronic device including the standalone BT module and the Wi-Fi/BT combo module may include controlling the standalone BT module to establish a connection according to Bluetooth communication with the first electronic device, based on the MAC address of the standalone BT module of the first electronic device.

According to an embodiment of the disclosure, the method of operating the second electronic device including the standalone BT module and the Wi-Fi/BT combo module may include controlling the Wi-Fi/BT combo module to establish a connection according to Wi-Fi communication with the first electronic device, based on the Wi-Fi connection information of the second electronic device.

According to an embodiment of the disclosure, the method of operating the second electronic device including the standalone BT module and the Wi-Fi/BT combo module may further include controlling the Wi-Fi/BT combo module to receive a Bluetooth message including the MAC address of the standalone BT module of the first electronic device.

According to an embodiment of the disclosure, the method of operating the second electronic device including the standalone BT module and the Wi-Fi/BT combo module may further include controlling the standalone BT module to transmit, to the first electronic device, a connection request based on the Bluetooth communication with the first electronic device, using the MAC address of the standalone BT module of the first electronic device.

According to an embodiment of the disclosure, the method of operating the second electronic device including the standalone BT module and the Wi-Fi/BT combo module may further include controlling the standalone BT module to perform a connection operation based on the Bluetooth communication with the first electronic device, in response to transmitting the connection request.

According to an embodiment of the disclosure, the method of operating the second electronic device including the standalone BT module and the Wi-Fi/BT combo module may further include controlling the Wi-Fi/BT combo module to transmit, to the first electronic device, a Bluetooth message including the Wi-Fi connection information of the second electronic device, the Wi-Fi connection information corresponding to a wireless network generated for a Soft AP.

According to an embodiment of the disclosure, the method of operating the second electronic device including the standalone BT module and the Wi-Fi/BT combo module may further include controlling the Wi-Fi/BT combo module to receive, from the first electronic device, a connection request based on the Wi-Fi connection information of the second electronic device.

According to an embodiment of the disclosure, the method of operating the second electronic device including the standalone BT module and the Wi-Fi/BT combo module may further include controlling the Wi-Fi/BT combo module to perform a connection operation based on the Wi-Fi communication with the first electronic device, based on the connection request.

According to an embodiment of the disclosure, provided is a non-transitory computer-readable recording medium having one or more instructions recorded thereon, wherein the one or more instructions, when executed by at least one processor of a first electronic device individually and/or collectively, cause the first electronic device including a standalone BT module and a Wi-Fi/BT combo module to control the Wi-Fi/BT combo module to obtain a MAC address of the standalone BT module, based on powering on of the first electronic device, control the Wi-Fi/BT combo module to establish a connection according to Bluetooth communication with a second electronic device, control the Wi-Fi/BT combo module to transmit the MAC address of the standalone BT module to the second electronic device via the Bluetooth communication connection between the Wi-Fi/BT combo module and the second electronic device and receive Wi-Fi connection information of the second electronic device, control the standalone BT module to establish a connection according to Bluetooth communication with the second electronic device, based on the MAC address of the standalone BT module transmitted to the second electronic device, and control the Wi-Fi/BT combo module to establish a connection according to Wi-Fi communication with the second electronic device, based on the Wi-Fi connection information of the second electronic device received from the second electronic device.

According to an embodiment of the disclosure, provided is a non-transitory computer readable recording medium having one or more instructions recorded thereon, wherein the one or more instructions, when executed by at least one processor of a second electronic device individually and/or collectively, cause the second electronic device including a standalone BT module and a Wi-Fi/BT combo module to control the Wi-Fi/BT combo module to establish a connection according to Bluetooth communication, in response to receiving a Bluetooth advertising packet from a first electronic device, control the Wi-Fi/BT combo module to receive a MAC address of the standalone BT module of the first electronic device from the first electronic device via the Bluetooth communication connection between the Wi-Fi/BT combo module and the first electronic device and transmit Wi-Fi connection information of the second electronic device to the first electronic device, control the standalone BT module to establish a connection according to Bluetooth communication with the first electronic device, based on the MAC address of the standalone BT module of the first electronic device, and control the Wi-Fi/BT combo module to establish a connection according to Wi-Fi communication with the first electronic device, based on the Wi-Fi connection information of the second electronic device.

Some embodiments of the disclosure may be implemented in the form of a recording medium including computer-executable instructions such as program modules executable by a computer. A computer-readable recording medium may be any available media that are accessible by the computer and may include any volatile and non-volatile media and any removable and non-removable media. In addition, the computer-readable recording medium may include a computer storage medium. The computer storage medium may include any volatile, non-volatile, removable, and non-removable media that are implemented in any method or technology for storage of information such as computer-readable instructions, data structures, program modules, or other data.

The embodiments of the disclosure may be in a software (S/W) program including instructions stored in a computer-readable storage medium.

The computer is a device capable of calling the stored instructions from the storage medium and operating according to the embodiments of the disclosure in accordance with the called instructions, and may include an electronic device according to the embodiments of the disclosure.

The computer-readable storage medium may be provided in the form of a non-transitory storage medium. In this regard, the term “non-transitory” means that the storage medium does not include a signal and is tangible, but does not distinguish that data is stored semi-permanently or temporarily on the storage medium.

In addition, a control method according to the embodiments of the disclosure may be provided in a computer program product. The computer program product may be traded as merchandise between a seller and a purchaser.

The computer program product may include an S/W program and a computer-readable storage medium having stored thereon the S/W program. For example, the computer program product may include a product (for example, a downloadable application) in the form of an S/W program distributed electronically via a manufacturer of a device or an electronic market (for example, Google Play Store or App Store). For electronic distribution, at least a part of the S/W program may be stored on the storage medium or may be generated temporarily. In this case, the storage medium may be a storage medium of a server of the manufacturer, a server of the electronic market, or a relay server for temporarily storing the S/W program.

The computer program product may include a storage medium of a server or a storage medium of a device, in a system including the server and the device. Alternatively, when there is a third device (for example, a smartphone) that communicates with the server or the device, the computer program product may include a storage medium of the third device. Alternatively, the computer program product may include an S/W program that is transmitted from the server to the device or the third device or from the third device to the device.

In this case, one of the server, the device, and the third device may perform the method according to the embodiments of the disclosure by executing the computer program product. Alternatively, at least two of the server, the device, and the third device may divide and perform the method according to the embodiments of the disclosure by executing the computer program product.

For example, the server (for example, a cloud server or an artificial intelligence server) may execute the computer program product stored in the server, thereby controlling the device to perform the method according to the embodiments of the disclosure, the device being connected for communication with the server.

As another example, the third device may execute the computer program product, thereby controlling the device to perform the method according to the embodiments of the disclosure, the device being connected for communication with the third device. When the third device executes the computer program product, the third device may download the computer program product from the server, and may execute the downloaded computer program product. Alternatively, the third device may perform the method according to the embodiments of the disclosure by executing a pre-loaded computer program product.

At least one of the components, elements, modules, and units (collectively "components" in this paragraph) represented by a block in the drawings such as FIGS. 1, 9 and 10 may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU), a microprocessor, or the like that performs the respective functions.

It will be understood by those of ordinary skill in the art that the embodiments of the disclosure are provided for illustration and may be implemented in different ways without departing from the spirit and scope of the disclosure. Therefore, it should be understood that the foregoing embodiments of the disclosure are provided for illustrative purposes only and are not to be construed in any way as limiting the disclosure. For example, each component described as a single type may be implemented in a distributed manner, and likewise, components described as being distributed may be implemented as a combined type.

The scope of the disclosure should be defined by the appended claims and equivalents thereof, and any changes or modifications derived from the appended claims and equivalents thereof should be construed as falling within the scope of the disclosure.

What is claimed is:

1. A first electronic device comprising:
a communication interface comprising a standalone Bluetooth (BT) interface and a combined Wi-Fi and BT interface;
memory storing one or more instructions; and
at least one processor comprising processing circuitry and configured to execute the one or more instructions stored in the memory,
wherein the one or more instructions, when executed by the at least one processor individually or collectively, cause the first electronic device to:
based on the first electronic device being powered on, control the combined Wi-Fi and BT interface to obtain a media access control (MAC) address of the standalone BT interface;
control the combined Wi-Fi and BT interface to establish a first connection according to Bluetooth communication with a second electronic device;
control the combined Wi-Fi and BT interface to transmit the MAC address of the standalone BT interface to the second electronic device via the first connection and receive Wi-Fi connection information associated with the second electronic device;
control the standalone BT interface to establish a second connection according to Bluetooth communication with the second electronic device, based on the MAC address of the standalone BT interface; and
control the combined Wi-Fi and BT interface to establish a third connection according to Wi-Fi communication with the second electronic device, based on the Wi-Fi connection information associated with the second electronic device.

2. The first electronic device of claim 1, wherein the one or more instructions, when executed by the at least one processor individually or collectively, further cause the first electronic device to, based on the first electronic device being powered on, control the combined Wi-Fi and BT interface to transmit a request to the standalone BT interface to enter a pairing mode.

3. The first electronic device of claim 1, wherein the one or more instructions, when executed by the at least one processor individually or collectively, further cause the first electronic device to:
control the combined Wi-Fi and BT interface to transmit, to the second electronic device, a first Bluetooth message comprising the MAC address of the standalone BT interface;
receive, from the second electronic device, a request for the second connection, using the MAC address of the standalone BT interface, the first connection request being based on the Bluetooth communication; and
based on receiving the request for the second connection, control the standalone BT interface to perform an operation for the second connection based on the Bluetooth communication with the second electronic device.

4. The first electronic device of claim 1, wherein the one or more instructions, when executed by the at least one processor individually or collectively, further cause the first electronic device to:
control receiving of a second Bluetooth message from the second electronic device, the second Bluetooth message comprising the Wi-Fi connection information associated with the second electronic device;
control the combined Wi-Fi and BT interface to transmit, to the second electronic device, a request for the third connection based on the Wi-Fi communication with the second electronic device, based on the Wi-Fi connection information associated with the second electronic device; and
control the combined Wi-Fi and BT interface to perform an operation for the third connection based on the Wi-Fi communication with the second electronic device, based on the request for the third connection.

5. The first electronic device of claim 4, wherein the Wi-Fi connection information comprises a service set identifier (SSID) and a password of a network configured for a soft access point (AP) by the second electronic device.

6. The first electronic device of claim 1, wherein the one or more instructions, when executed by the at least one processor individually or collectively, further cause the first electronic device to:
control the combined Wi-Fi and BT interface to transmit audio-visual data to the second electronic device, via the third connection;
control the combined Wi-Fi and BT interface to receive at least one of Wi-Fi communication-related state information and Wi-Fi communication-related control information from the second electronic device via the first connection; and
control the standalone BT interface to receive, from the second electronic device, a control signal related to power control of the first electronic device via the second connection.

7. A second electronic device comprising:
a communication interface comprising a standalone Bluetooth (BT) interface and a combined Wi-Fi and BT interface;
memory storing one or more instructions; and
at least one processor configured to execute the one or more instructions stored in the memory,
wherein the one or more instructions, when executed by the at least one processor, individually or collectively, cause the second electronic device to:
based on receiving a Bluetooth advertising packet from a first electronic device, control the combined Wi-Fi and BT interface to establish a first connection according to Bluetooth communication with the first electronic device;
control the combined Wi-Fi and BT interface to receive a media access control (MAC) address of the standalone BT interface of the first electronic device from the first electronic device via the first connection, and transmit Wi-Fi connection information associated with the second electronic device to the first electronic device;
control the standalone BT interface to establish a second connection according to Bluetooth communication with the first electronic device, based on the MAC address of the standalone BT interface of the first electronic device; and
control the combined Wi-Fi and BT interface to establish a third connection according to Wi-Fi communication with the first electronic device, based on the Wi-Fi connection information associated with the second electronic device.

8. The second electronic device of claim 7, wherein the one or more instructions, when executed by the at least one processor, individually or collectively, further cause the second electronic device to:
control the combined Wi-Fi and BT interface to receive a first Bluetooth message comprising the MAC address of the standalone BT interface of the first electronic device;
control the standalone BT interface to transmit, to the first electronic device, a request for the second connection, based on the MAC address associated with the standalone BT interface of the first electronic device; and
based on transmitting the request for the second connection, control the standalone BT interface to perform an operation for the second connection based on the Bluetooth communication with the first electronic device.

9. The second electronic device of claim 7, wherein the one or more instructions, when executed by the at least one processor, individually or collectively, further cause the second electronic device to:
control the combined Wi-Fi and BT interface to transmit, to the first electronic device, a second Bluetooth message comprising the Wi-Fi connection information associated with the second electronic device, the Wi-Fi connection information corresponding to a wireless network generated for a soft access point (AP);
control the combined Wi-Fi and BT interface to receive, from the first electronic device, a request for the third connection based on the Wi-Fi connection information associated with the second electronic device; and
control the combined Wi-Fi and BT interface to perform an operation for the third connection based on the Wi-Fi communication with the first electronic device, based on the request for the third connection.

10. A method of operating a first electronic device comprising a standalone Bluetooth (BT) interface and a combined Wi-Fi and BT interface, the method comprising:
based on the first electronic device being powered on, controlling the combined Wi-Fi and BT interface to obtain a media access control (MAC) address of the standalone BT interface;
controlling the combined Wi-Fi and BT interface to establish a first connection according to Bluetooth communication with a second electronic device;
controlling the combined Wi-Fi and BT interface to transmit the MAC address of the standalone BT interface to the second electronic device via the first connection and receive Wi-Fi connection information associated with the second electronic device;
controlling the standalone BT interface to establish a second connection according to Bluetooth communication with the second electronic device, based on the MAC address of the standalone BT interface; and
controlling the combined Wi-Fi and BT interface to establish a third connection according to Wi-Fi communication with the second electronic device, based on the Wi-Fi connection information associated with the second electronic device.

11. The method of claim 10, further comprising controlling the combined Wi-Fi and BT interface to transmit a request to the standalone BT interface to enter a pairing mode, based on the powering on of the first electronic device.

12. The method of claim 10, further comprising:
controlling the combined Wi-Fi and BT interface to transmit, to the second electronic device, a first Bluetooth message comprising the MAC address of the standalone BT interface;
receiving, from the second electronic device, a request for the second connection based on the Bluetooth communication, using the MAC address of the standalone BT interface; and
controlling the standalone BT interface to perform an operation for the second connection based on the Bluetooth communication with the second electronic device, in response to receiving the request for the second connection.

13. The method of claim 10, further comprising:
controlling receiving of a second Bluetooth message from the second electronic device, the second Bluetooth message comprising the Wi-Fi connection information associated with the second electronic device;
controlling the combined Wi-Fi and BT interface to transmit, to the second electronic device, a request for the third connection based on the Wi-Fi connection information associated with the second electronic device, the second connection request being based on the Wi-Fi communication; and
controlling the combined Wi-Fi and BT interface to perform an operation for the third connection, based on the request for the third connection.

14. The method of claim 13, wherein the Wi-Fi connection information comprises a service set identifier (SSID) and a password of a soft access point (AP) of the second electronic device.

15. The method of claim 10, further comprising:
controlling the combined Wi-Fi and BT interface to transmit audio-visual data to the second electronic device, via the third connection;
controlling the combined Wi-Fi and BT interface to receive at least one of Wi-Fi communication-related state information and Wi-Fi communication-related control information from the second electronic device via the first connection; and
controlling the standalone BT interface to receive, from the second electronic device, a control signal related to power control of the first electronic device, via the second connection.
